(19) United States
(12) Patent Application Publication
(10) Pub. No.: US 2026/0161435 A1
(43) Pub. Date: Jun. 11, 2026

(54) PRINTING SYSTEM, CONTROL METHOD OF PRINTING SYSTEM, AND STORAGE MEDIUM

(71) Applicant: CANON KABUSHIKI KAISHA, Tokyo (JP)

(72) Inventor: YUKI INOUE, Tokyo (JP)

(21) Appl. No.: 19/406,306

(22) Filed: Dec. 2, 2025

(30) Foreign Application Priority Data
Dec. 10, 2024 (JP) 2024-215472

(51) Int. Cl. G06F 9/451; G06F 16/34; H04N 1/00

(52) U.S. Cl. CPC G06F 9/453; G06F 16/345; H04N 1/00464

(57) ABSTRACT

A printing system includes a printing apparatus and an information processing apparatus, wherein the printing apparatus includes at least one memory that stores a set of instructions, and at least one processor that executes the instructions causing the printing apparatus to transmit a user manual activation instruction signal for a user manual of the printing apparatus to the information processing apparatus directly or via another apparatus, and display information about the user manual activation instruction signal, wherein the information processing apparatus includes at least one memory that stores a set of instructions, and at least one processor that executes the instructions causing the information processing apparatus to receive the user manual activation instruction signal, and, in a case where the user manual activation instruction signal is received, display user manual information about the user manual of the printing apparatus based on the user manual activation instruction signal.

### BACKGROUND

### Field of the Technology

The present disclosure relates to a printing system, a control method of the printing system, and a storage medium.

### Description of the Related Art

In recent years, many printing apparatuses such as printers have come to incorporate operation panels. The operation panels of such printing apparatuses are equipped with an information display unit consisting of a liquid crystal display panel or the like. This information display unit displays various types of setting information about the printing apparatus, information indicating the current state of the printing apparatus, etc. For example, when the printing apparatus performs copying, copy setting information is displayed on the operation panel (information display unit). During copy execution, information indicating the state of the printing apparatus is displayed.

Similarly, when printing is initiated from an information processing apparatus such as a personal computer (PC) and a smartphone, information during printing is displayed on the operation panel (information display unit) of the printing apparatus. Moreover, when an error such as a paper-out error occurs during printing, information about the error is displayed on the operation panel of the printing apparatus. Users operate the printing apparatus based on such information displayed on the operation panel.

However, some users may be unsure of how to operate the printing apparatus with only the information displayed on the operation panel (information display unit) of the printing apparatus. For such users, the printing apparatus has a function of displaying user manuals and other information for supplementing the information displayed on the operation panel of the printing apparatus. For example, a help button is disposed near the information display unit of the operation panel of the printing apparatus, and when the help button is pressed, explanatory information for supplementing the information previously displayed on the information display unit is displayed.

Japanese Patent Laid-Open No. 2008-145948 describes a technique for displaying error content on an operation panel when an error occurs in a printing apparatus, and in a case where a user manual print button disposed on the printing apparatus is pressed, printing out user manual information corresponding to the occurred error.

Some printing apparatuses have operation panels with small display areas. The technique for displaying explanatory information for supplementing the information previously displayed on the operation panel (information display unit) of the printing apparatus may thus have difficulty in fully presenting detailed user manual information to users. Moreover, the technique described in Japanese Patent Laid-Open No. 2008-145948 needs sheets to present the user manual information to users. In a case where, for example, sheets are unavailable or the print-out function of the printing apparatus fails, it is difficult to present the detailed user manual information to users.

### SUMMARY

According to an aspect of the present disclosure, a printing system includes a printing apparatus configured to perform printing, and an information processing apparatus configured to be communicably connected to the printing apparatus, wherein the printing apparatus includes at least one memory that stores a set of instructions, and at least one processor that executes the instructions causing the printing apparatus to perform operations comprising transmitting a user manual activation instruction signal for a user manual of the printing apparatus to the information processing apparatus directly or via another apparatus, and displaying information about the user manual activation instruction signal, wherein the information processing apparatus includes at least one memory that stores a set of instructions, and at least one processor that executes the instructions causing the information processing apparatus to perform operations comprising receiving the user manual activation instruction signal, and, in a case where the user manual activation instruction signal is received, displaying user manual information about the user manual of the printing apparatus based on the user manual activation instruction signal.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a schematic configuration of a printing system according to a first embodiment.

FIG. 2 is a diagram illustrating an example of a hardware configuration of a terminal apparatus (information processing apparatus) according to the first embodiment.

FIG. 3 is a diagram illustrating an example of a hardware configuration of a printer (printing apparatus) according to the first embodiment.

FIG. 4 is a diagram illustrating an operation panel of the printer (printing apparatus) according to the first embodiment.

FIG. 5 is a diagram illustrating an example of the operation panel of the printer (printing apparatus) according to the first embodiment, and shows a display example of an information display unit when an OK button is pressed in the state illustrated in FIG. 4.

FIG. 6 is a diagram illustrating an example of the operation panel of the printer (printing apparatus) according to the first embodiment, and shows a display example of the information display unit when a selection button is pressed in the state illustrated in FIG. 4.

FIG. 7 is a diagram illustrating a display example of a display unit of the terminal apparatus (information processing apparatus) according to the first embodiment when a help button is pressed in the state illustrated in FIG. 5.

FIG. 8 is a diagram illustrating an example of the operation panel of the printer (printing apparatus) according to the first embodiment, and shows a display example of the information display unit when an error has occurred during execution of printing or copying based on print instructions from the terminal apparatus (information processing apparatus).

FIG. 9 is a diagram illustrating a display example of the display unit of the terminal apparatus (information processing apparatus) according to the first embodiment when the help button is pressed in the state illustrated in FIG. 8.

FIG. 10 is a flowchart illustrating a control method of the printing system according to the first embodiment, and shows an example of processing of the printer when the help button on the operation panel of the printer (printing apparatus) is pressed.

FIG. 11 is a diagram illustrating the first embodiment, illustrates an example of a user manual activation instruction signal that the printer (printing apparatus) transmits to a communicatively connected terminal apparatus (information processing apparatus) when the help button is pressed in the state illustrated in FIG. 5.

FIG. 12 is a flowchart illustrating a control method of the printing system according to the first embodiment, and shows an example of processing of the terminal apparatus (information processing apparatus) when the user manual activation instruction signal is transmitted from the communicatively connected printer (printing apparatus).

FIG. 13 is a flowchart illustrating a control method of the printing system according to a second embodiment, and shows an example of processing of the printer when the help button on the operation panel of the printer (printing apparatus) is pressed.

FIG. 14 is a diagram illustrating the second embodiment, illustrates an example of a user manual activation instruction signal that the printer (printing apparatus) transmits to a communicatively connected terminal apparatus (information processing apparatus) when the help button is pressed in the state illustrated in FIG. 5.

FIG. 15 is a flowchart illustrating a control method of the printing system according to the second embodiment, and shows an example of processing of the terminal apparatus (information processing apparatus) when the user manual activation instruction signal is transmitted from the communicatively connected printer (printing apparatus).

FIG. 16 is a diagram illustrating the second embodiment, and shows an example of a selection screen that is displayed on a display unit of the terminal apparatus (information processing apparatus) to have users select display language in step S1501 of FIG. 15.

FIG. 17 is a diagram illustrating a third embodiment, illustrates an example of a user manual activation instruction signal that the printer (printing apparatus) transmits to a communicatively connected terminal apparatus (information processing apparatus) when the help button is pressed in the state illustrated in FIG. 5.

FIG. 18 is a flowchart illustrating a control method of the printing system according to the third embodiment, and shows an example of processing of the terminal apparatus (information processing apparatus) when the user manual activation instruction signal is transmitted from the communicatively connected printer (printing apparatus).

FIG. 19 is a flowchart illustrating a control method of a printing system according to a fourth embodiment, and shows an example of processing of a printer when an error occurs in the printer (printing apparatus).

FIG. 20 is a diagram illustrating an example of an operation panel of a printer (printing apparatus) according to a fifth embodiment, and shows a display example where a message for prompting a user to input a user ID is displayed on an information display unit.

FIG. 21 is a diagram illustrating an example of the operation panel of the printer (printing apparatus) according to the fifth embodiment, and shows a display example where a message for prompting registration of a terminal apparatus (information processing apparatus) communicatively connected to the printer being used by the user is displayed on the information display unit.

FIG. 22 is a chart illustrating an example of an association information table that is held in a read-only memory (ROM) of the printer (printing apparatus) according to the fifth embodiment, where information about users and information about the users'terminal apparatuses (information processing apparatuses) are associated with each other.

FIG. 23 is a flowchart illustrating a control method of the printing system according to the fifth embodiment, and shows an example of processing of the printer when the help button on the operation panel of the printer (printing apparatus) is pressed.

FIG. 24 is a diagram illustrating an example of the operation panel of the printer (printing apparatus) according to the fifth embodiment, and shows a display example where error message information is displayed on the information display unit in step S2304 of FIG. 23.

FIG. 25 is a diagram illustrating an example of a schematic configuration of a printing system according to a sixth embodiment.

FIG. 26 is a diagram illustrating a display example of a push notification from a push notification server (server apparatus) on a display unit of a terminal apparatus (information processing apparatus) according to the sixth embodiment.

FIG. 27 is a flowchart illustrating a control method of the printing system according to the sixth embodiment, and shows an example of processing of the printer when the help button on the operation panel of the printer (printing apparatus) is pressed.

FIG. 28 is a flowchart illustrating a control method of the printing system according to the sixth embodiment, and shows an example of processing of the push notification server (server apparatus) when a user manual activation instruction signal is transmitted from the printer (printing apparatus).

FIG. 29 is a flowchart illustrating a control method of the printing system according to the sixth embodiment, and shows an example of processing of the terminal apparatus (information processing apparatus) when a push notification is transmitted from the push notification server (server apparatus).

FIG. 30 is a flowchart illustrating a control method of a printing system according to a seventh embodiment, and shows a first example of processing of a printer when a help button on an operation panel of the printer (printing apparatus) is pressed.

FIG. 31 is a diagram illustrating an example of the operation panel of the printer (printing apparatus) according to the seventh embodiment, and shows a display example where message information is displayed on an information display unit in step S3001 of FIG. 30.

FIG. 32 is a flowchart illustrating a control method of the printing system according to the seventh embodiment, and shows a second example of the processing of the printer when the help button on the operation panel of the printer (printing apparatus) is pressed.

FIG. 33 is a diagram illustrating an example of the operation panel of the printer (printing apparatus) according to the seventh embodiment, and shows a display example where summarized user manual information is displayed on the information display unit in step S3201 of FIG. 32.

FIG. 34 is a flowchart illustrating a control method of the printing system according to an eighth embodiment, and shows an example of processing of the printer when the help button on the operation panel of the printer (printing apparatus) is pressed.

FIG. 35 is a flowchart illustrating a control method of the printing system according to a ninth embodiment, and shows an example of processing of the printer when the help button on the operation panel of the printer (printing apparatus) is pressed.

FIG. 36 is a diagram illustrating an example of the operation panel of the printer (printing apparatus) according to the ninth embodiment, and shows a display example where guidance information for communicatively connecting the printer and a terminal apparatus is displayed on an information display unit in step S3503 of FIG. 35.

### DESCRIPTION OF THE EMBODIMENTS

The embodiments for implementing the present disclosure will be described below with reference to the drawings. It should be noted that the embodiments described below do not limit the present disclosure as defined in the claims, and not all combinations of features described in the embodiments are necessarily essential for the solutions of the present disclosure.

### First Embodiment

A first embodiment will be described first.

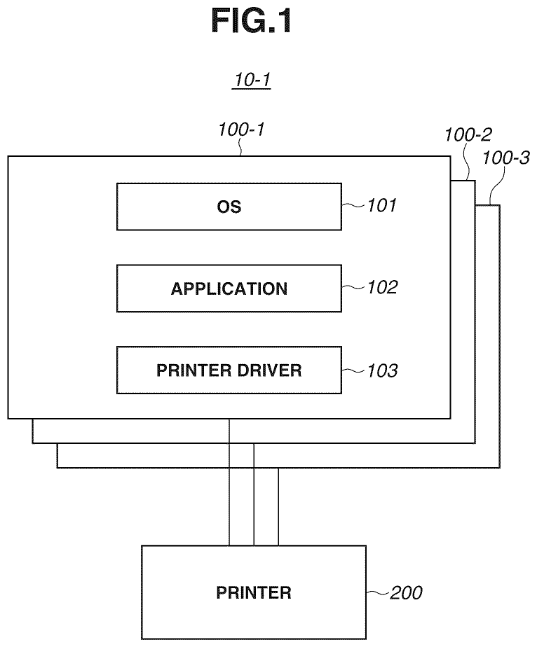

FIG. 1 is a diagram illustrating an example of a schematic configuration of a printing system 10 according to the first embodiment. In the following description, as illustrated in FIG. 1, the printing system 10 according to the first embodiment may be referred to as a “printing system 10-1” when needed.

As illustrated in FIG. 1, the printing system 10-1 includes a plurality of terminal apparatuses 100-1 to 100-3 and a printer 200. In the following description, items common to the plurality of terminal apparatuses 100-1 to 100-3 will be described by simply referring to “terminal apparatus 100”.

The terminal apparatus 100, i.e., each of the plurality of terminal apparatuses 100-1 to 100-3 is an information processing apparatus configured to be communicatively connectable to the printer 200. For example, the terminal apparatus (information processing apparatus) 100 can be communicatively connected to the printer 200 via a local area network (LAN) or a Universal Serial Bus (USB) cable. Examples of the terminal apparatus 100 include information processing apparatuses such as a personal computer (PC) and a smartphone. As illustrated in FIG. 1, the terminal apparatus 100 includes an operating system (OS) 101, an application 102, and a printer driver 103 as its software components.

The printer (printing apparatus) 200 is a printing apparatus that performs printing. The printer 200 is configured to be communicatively connectable to each terminal apparatus 100.

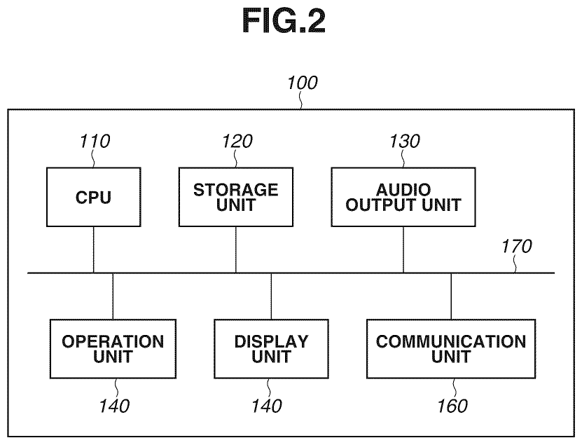

FIG. 2 is a diagram illustrating an example of a hardware configuration of the terminal apparatus (information processing apparatus) 100 according to the first embodiment. As illustrated in FIG. 2, the terminal apparatus 100 includes a central processing unit (CPU) 110, a storage unit 120, an audio output unit 130, an operation unit 140, a display unit 150, a communication unit 160, and a bus 170 as its hardware components.

The CPU 110 is a processor that controls the entire terminal apparatus (information processing apparatus) 100 and performs various types of processing. The CPU 110 implements the functions of the OS 101, the application 102, and the printer driver 103 illustrated in FIG. 1 by executing programs stored in the storage unit 120.

The storage unit 120 includes a read-only memory (ROM) and a random access memory (RAM), for example. The storage unit 120 stores programs and various types of information (including data) that are needed when the CPU 110 controls the entire terminal apparatus (information processing apparatus) 100 and performs various types of processing. The storage unit 120 also stores various types of information (including data) obtained by the CPU 110 controlling the entire terminal apparatus 100 and performing various types of processing. Examples of the programs stored in the storage unit 120 include the OS 101, the application 102, and the printer driver 103 illustrated in FIG. 1. Transmission and reception of print instructions and various types of information to/from the printer (printing apparatus) 200 communicatively connected to the terminal apparatus 100 are performed via the application 102 and the printer driver 103 illustrated in FIG. 1. Print instructions may be issued by the application 102 having a print function instead of the printer driver 103. The application 102 can also receive information from the printer 200, display content based on the received information on the display unit 150, and display user manual information about the printer 200 on the display unit 150.

The audio output unit 130 includes a speaker, for example. The audio output unit 130 provides audio output based on control of the CPU 110.

The operation unit 140 includes a mouse, a keyboard, and/or a touch operation panel, for example. The operation unit 140 accepts the user's operation input, and inputs information about the accepted operation input to the CPU 110.

The display unit 150 includes a liquid crystal display, for example. The display unit 150 displays various images and various types of information based on control of the CPU 110.

The communication unit 160 includes a wireless LAN interface and/or a USB interface, for example. The communication unit 160 communicates with other apparatuses (for example, the printer (printing apparatus) 200) based on control of the CPU 110.

The bus 170 is a system bus that communicatively interconnects the CPU 110, the storage unit 120, the audio output unit 130, the operation unit 140, the display unit 150, and the communication unit 160.

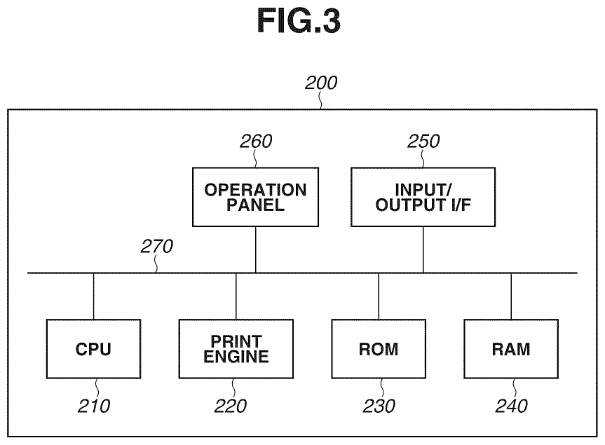

FIG. 3 is a diagram illustrating an example of a hardware configuration of the printer (printing apparatus) 200 according to the first embodiment. As illustrated in FIG. 3, the printer 200 includes a CPU 210, a print engine 220, a ROM 230, a RAM 240, an input/output interface (I/F) 250, an operation panel 260, and a bus 270 as its hardware components.

The CPU 210 is a processor that controls the entire printer (printing apparatus) 200 and performs various types of processing.

The print engine 220 performs printing on recording media, such as sheets, based on control of the CPU 210. For example, the print engine 220 performs printing to form images on recording media using recording agents such as ink based on various types of information (including data) stored in the RAM 240 and a print job received from the terminal apparatus 100, and outputs the printed recording media.

The ROM 230 stores programs and various types of information (including data) for the CPU 210 to control the entire printer (printing apparatus) 200 and perform various types of processing. Examples of the various types of information (including data) stored in the ROM 230 include fixed data such as data tables, as well as the user manual information about the user manual of the printer 200.

The RAM 240 includes a static random access memory (SRAM) that needs a backup power supply, for example. The RAM 240 retains various types of information (including data) using a primary battery for data backup, for example. The RAM 240 also stores program control variables and the like for which erasure of information (including data) is to be avoided, for example. The RAM 240 is used as a work memory of the CPU 210 and also used as a temporary storage buffer for various types of received information (including data), for example.

The input/output I/F 250 communicates with other apparatuses (such as the terminal apparatus (information processing apparatus) 100) via a LAN or a USB cable, for example, based on control of the CPU 210.

The operation panel 260 is a panel for users to operate, for example, and is used to configure various functions and display status, etc., of the printer (printing apparatus) 200.

The bus 270 is a system bus that communicatively interconnects the CPU 210, the print engine 220, the ROM 230, the RAM 240, the input/output I/F 250, and the operation panel 260.

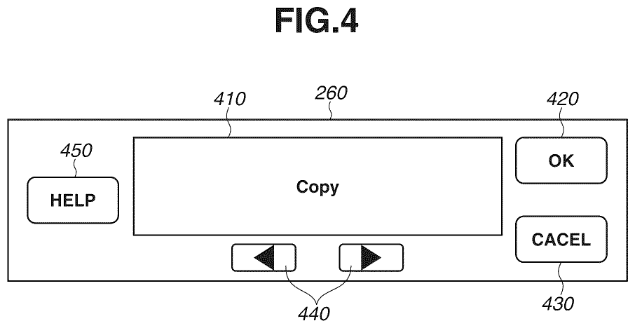

FIG. 4 is a diagram illustrating an example of the operation panel 260 of the printer (printing apparatus) 200 according to the first embodiment. As illustrated in FIG. 4, the operation panel 260 includes an information display unit 410, an OK button 420, a cancel button 430, selection buttons 440, and a help button 450.

The information display unit 410 displays, for example, function information, setting information, and status information about the printer (printing apparatus) 200, status information about the terminal apparatus (information processing apparatus) 100, and so on. For example, the information display unit 410 illustrated in FIG. 4 displays “copy” as setting information (function information) about the printer 200.

By pressing the OK button 420, the user can permit execution, permit setting, or advance processing related to the information displayed on the information display unit 410. For example, the user can execute a copy function by pressing the OK button 420 when “copy” is displayed on the information display unit 410 as illustrated in FIG. 4.

By pressing the cancel button 430, the user can cancel processing of the information displayed on the information display unit 410.

By pressing the selection buttons 440, the user can switch information displayed on the information display unit 410. For example, the user can change the information displayed on the information display unit 410 to the next option by pressing the selection buttons 440.

By pressing the help button 450, the user can switch display to explanatory information for supplementing the information previously displayed on the information display unit 410, for example. The user, by pressing the help button 450, can display corresponding user manual information about the printer 200 on the display unit 150 of the terminal apparatus (information processing apparatus) 100 communicatively connected to the printer (printing apparatus) 200, for example.

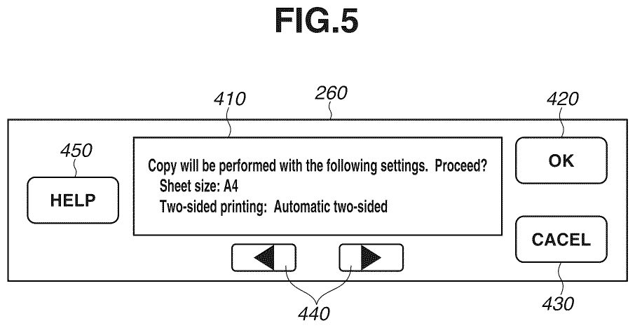

FIG. 5 is a diagram illustrating an example of the operation panel 260 of the printer (printing apparatus) 200 according to the first embodiment, and shows a display example of the information display unit 410 when the OK button 420 is pressed in the state illustrated in FIG. 4. In FIG. 5, components similar to those illustrated in FIG. 4 are denoted by the same reference numerals. A detailed description thereof will be omitted.

When the OK button 420 is pressed in the state illustrated in FIG. 4, the display of the information display unit 410 is switched to that illustrated in FIG. 5, for example. When the OK button 420 is pressed in the state illustrated in FIG. 5, the printer (printing apparatus) 200 performs copy processing. When the cancel button 430 is pressed in the state illustrated in FIG. 5, the state illustrated in FIG. 4 can be restored.

When the selection buttons 440 are pressed in the state illustrated in FIG. 4, the information displayed on the information display unit 410 can be changed from copy to the next option.

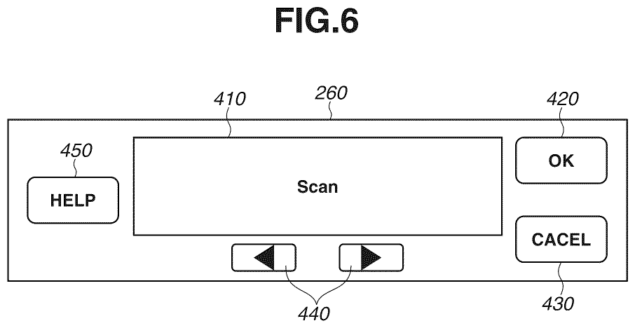

FIG. 6 is a diagram illustrating an example of the operation panel 260 of the printer (printing apparatus) 200 according to the first embodiment, and shows a display example of the information display unit 410 when either one of the selection buttons 440 is pressed in the state illustrated in FIG. 4. In FIG. 6, components similar to those illustrated in FIGS. 4 and 5 are denoted by the same reference numerals. A description thereof will be omitted.

When the selection button 440 is pressed in the state illustrated in FIG. 4, the display is switched to “scan” on the information display unit 410 illustrated in FIG. 6 (switched from “copy” of FIG. 4 to “scan”).

Suppose, in the state illustrated in FIG. 5, the user wants to change the sheet size or two-sided printing setting, is unsure of how, and presses the help button 450. In such a case, corresponding user manual information about the printer 200 can be displayed on the display unit 150 of the terminal apparatus (information processing apparatus) 100 communicatively connected to the printer (printing apparatus) 200.

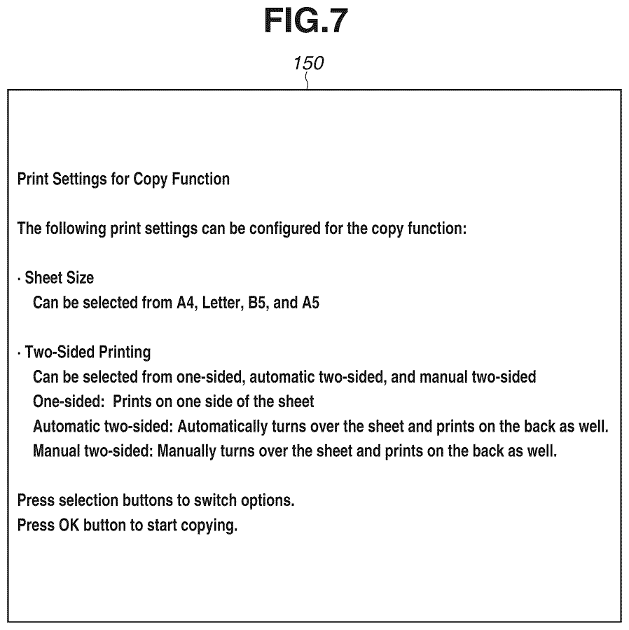

FIG. 7 is a diagram illustrating a display example of the display unit 150 of the terminal apparatus (information processing apparatus) 100 according to the first embodiment when the help button 450 is pressed in the state illustrated in FIG. 5.

The display unit 150 of the terminal apparatus (information processing apparatus) 100 illustrated in FIG. 7 displays user manual information that is detailed information about the copy print settings (such as what settings can be configured and the method for configuring the settings). The information display unit 410 of the operation panel 260 of the printer (printing apparatus) 200 is unable to fully display this user manual information, i.e., detailed information because of its small display area.

In the present embodiment, the user manual information that is detailed information is therefore displayed on the display unit 150 of the terminal apparatus 100 with a display area larger than that of the information display unit 410, whereby the user manual information that is detailed information can be presented to the user.

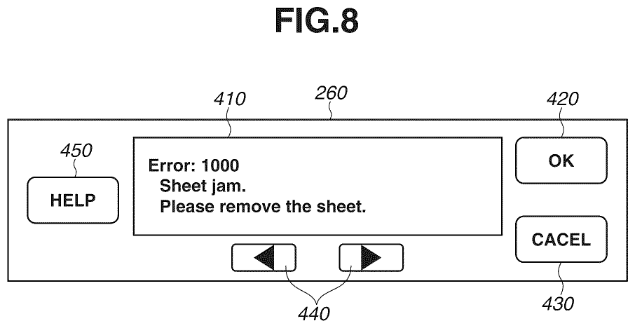

FIG. 8 is a diagram illustrating an example of the operation panel 260 of the printer (printing apparatus) 200 according to the first embodiment, and shows a display example of the information display unit 410 when an error has occurred during execution of printing or copying based on print instructions from the terminal apparatus (information processing apparatus) 100. In FIG. 8, components similar to those illustrated in FIGS. 4 to 6 are denoted by the same reference numerals. A detailed description thereof will be omitted.

Specifically, the information display unit 410 of the operation panel 260 illustrated in FIG. 8 demonstrates a display example in the event of a sheet jam error. More specifically, the information display unit 410 of the operation panel 260 illustrated in FIG. 8 displays a message indicating the error number and a simple description of the error. The user can see, from the message displayed on the information display unit 410 illustrated in FIG. 8, that the sheet needs to be removed, but may not know how to remove the sheet. In such a case, the user can press the help button 450 on the operation panel 260 illustrated in FIG. 8 to check user manual information that is detailed information thereof.

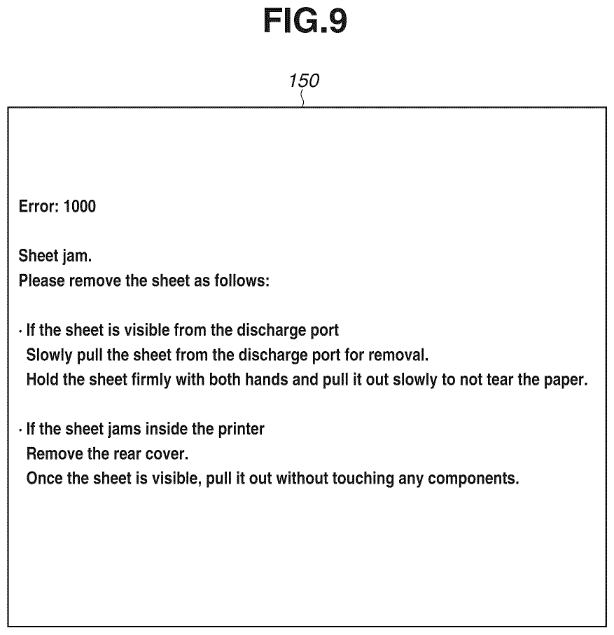

FIG. 9 is a diagram illustrating a display example of the display unit 150 of the terminal apparatus (information processing apparatus) 100 according to the first embodiment when the help button 450 is pressed in the state illustrated in FIG. 8.

The method for removing the sheet depends on where the sheet jams in the printer (printing apparatus) 200. The display unit 150 of the terminal apparatus (information processing apparatus) 100 illustrated in FIG. 9 displays user manual information that is detailed information about the solutions. The information display unit 410 of the operation panel 260 of the printer 200 cannot fully display the user manual information that is detailed information because of its small display area. In the present embodiment, the user manual information that is detailed information is therefore displayed on the display unit 150 of the terminal apparatus 100 with a display area larger than that of the information display unit 410, whereby the user manual information that is detailed information can be presented to the user. While the display unit 150 of the terminal apparatus 100 illustrated in FIG. 9 displays user manual information consisting of messages alone, user manual information including illustrations and moving images may also be displayed. The user manual information can also be made easier for the user to understand, for example, by displaying the user manual information as a slide show on the information display unit 410 of the operation panel 260 of the printer 200.

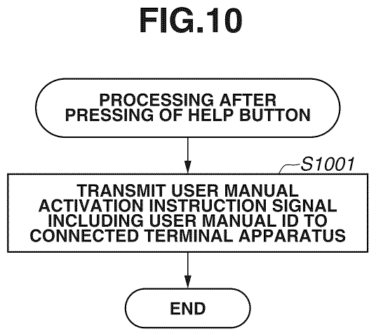

FIG. 10 is a flowchart illustrating a control method of the printing system 10 according to the first embodiment, and shows an example of processing of the printer 200 when the help button 450 on the operation panel 260 of the printer (printing apparatus) 200 is pressed.

In the first embodiment, when the user presses the help button 450 on the operation panel 260 of the printer (printing apparatus) 200, the processing proceeds to step S1001 of FIG. 10.

In step S1001 of FIG. 10, the input/output I/F 250 transmits a user manual activation instruction signal for the user manual of the printer 200 to the communicatively connected terminal apparatus (information processing apparatus) 100 based on control of the CPU 210. Specifically, in step S1001, the input/output I/F 250 transmits a user manual activation instruction signal including information about a user manual identifier (ID) for identifying the user manual of the printer 200. The input/output I/F 250 of the printer 200 that transmits the user manual activation instruction signal in step S1001 of FIG. 10 serves as a transmission unit.

In the present embodiment, in step S1001 of FIG. 10, the information display unit 410 of the operation panel 260 of the printer (printing apparatus) 200 displays information about the foregoing user manual activation instruction signal based on control of the CPU 210. The information display unit 410 of the printer 200 that displays the information about this user manual activation instruction signal serves as a first display unit.

Once the processing of step S1001 in FIG. 10 ends, the processing of the flowchart illustrated in FIG. 10 ends.

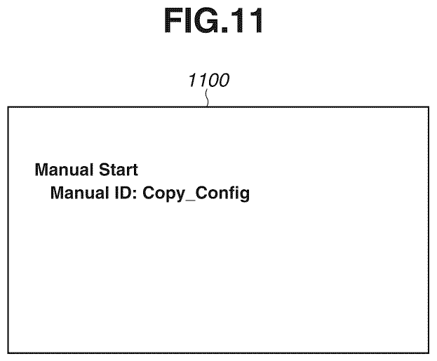

FIG. 11 is a diagram illustrates the first embodiment, and shows an example of a user manual activation instruction signal 1100 that the printer (printing apparatus) 200 transmits to the communicatively connected terminal apparatus (information processing apparatus) 100 when the help button 450 is pressed in the state illustrated in FIG. 5.

The user manual activation instruction signal 1100 illustrated in FIG. 11 includes “Manual Start” that is user manual activation instruction information, as well as “Manual ID” information that is instruction information indicating which description page of the user manual to display. In the state illustrated in FIG. 5, since the user manual's page describing copy setting needs to be displayed, “Manual ID: Copy_Config” that is the user manual ID indicating the description page is transmitted as the user manual activation instruction signal 1100 illustrated in FIG. 11.

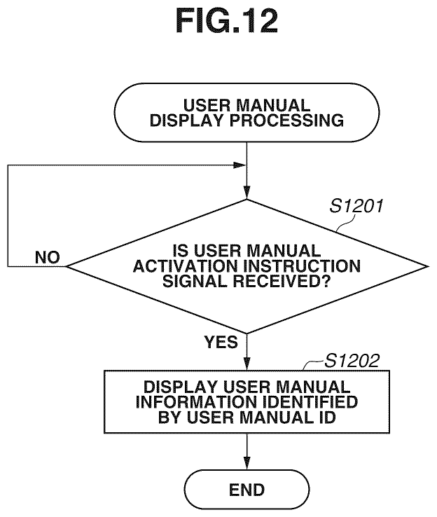

FIG. 12 is a flowchart illustrating a control method of the printing system 10 according to the first embodiment, and shows an example of processing of the terminal apparatus (information processing apparatus) 100 when the user manual activation instruction signal 1100 is transmitted from the communicatively connected printer (printing apparatus) 200.

When the user manual activation instruction signal 1100 is transmitted from the communicatively connected printer (printing apparatus) 200, the processing proceeds to step S1201 of FIG. 12.

In step S1201 of FIG. 12, the communication unit 160 determines whether the user manual activation instruction signal 1100 is received from the communicatively connected printer 200, based on control of the CPU 110. In the present embodiment, for example, the processing of the communication unit 160 and CPU 110 of the terminal apparatus (information processing apparatus) 100 in step S1201 of FIG. 12 is performed by the application 102 of the terminal apparatus 100. Here, the application 102 is constantly running (typically referred to as being “resident”) so that the user manual activation instruction signal can be received at any time, and regularly repeats determining whether the user manual activation instruction signal 1100 is received.

In a case where, in step S1201 of FIG. 12, the communication unit 160 (application 102) determines that the user manual activation instruction signal 1100 is not received from the communicatively connected printer (printing apparatus) 200 (NO in step S1201), the processing remains in standby in step S1201.

In a case where, in step S1201 of FIG. 12, the communication unit 160 (application 102) determines that the user manual activation instruction signal 1100 is received from the communicatively connected printer (printing apparatus) 200 (YES in step S1201), the processing proceeds to step S1202. Here, the communication unit 160 of the terminal apparatus (information processing apparatus) 100 that performs the processing for receiving the user manual activation instruction signal 1100 serves as a reception unit.

In step S1202 of FIG. 12, the display unit 150 displays user manual information about the user manual of the printer (printing apparatus) 200 based on the user manual activation instruction signal 1100 received by the communication unit 160. The display unit 150 of the terminal apparatus (information processing apparatus) 100 that displays this user manual information serves as a second display unit. Specifically, in step S1202 of FIG. 12, the display unit 150 displays, as user manual information, the information on the description page identified by the user manual ID included in the user manual activation instruction signal 1100 among user manuals stored in the ROM 230.

Once the processing of step S1202 in FIG. 12 ends, the processing of the flowchart illustrated in FIG. 12 ends.

The printing system 10 according to the first embodiment described above includes the printer (printing apparatus) 200 that performs printing, and the terminal apparatus (information processing apparatus) 100 communicatively connected to the printer 200. The printer 200 includes the input/output I/F 250 (transmission unit) that transmits the user manual activation instruction signal for the its user manual to the terminal apparatus 100, and the information display unit 410 (first display unit) that displays information related to the user manual activation instruction signal. The terminal apparatus 100 includes the communication unit 160 (reception unit) that receives the user manual activation instruction signal, and the display unit 150 (second display unit) that displays the user manual information about the user manual of the printer 200 based on the user manual activation instruction signal.

With such a configuration, detailed user manual information can be presented to the user in an easily understandable manner even in a case where the information display unit 410 of the printer 200 is unable to fully display the user manual information because of its small display area, etc. Specifically, the detailed user manual information can be presented to the user in an easily understandable manner by displaying the user manual information on the display unit 150 of the user's terminal apparatus 100 communicatively connected to the printer 200.

In the foregoing first embodiment, the user manual activation instruction signal 1100 illustrated in FIG. 11 includes the user manual ID for identifying the user manual of the printer (printing apparatus) 200. The display unit 150 (second display unit) of the terminal apparatus (information processing apparatus) 100 then displays the user manual information about the user manual identified by the user manual ID included in the user manual activation instruction signal 1100 (step S1202 of FIG. 12).

In the foregoing first embodiment, the input/output I/F 250 (transmission unit) of the printer (printing apparatus) 200 transmits the user manual activation instruction signal 1100 when the help button 450 that is a predetermined button disposed on the apparatus is operated.

### Second Embodiment

Next, a second embodiment will be described. In the following description of the second embodiment, items common to the foregoing first embodiment are omitted, and differences from the foregoing first embodiment will be described.

A printing system according to the second embodiment has a schematic configuration similar to that of the printing system 10 according to the first embodiment illustrated in FIG. 1. The terminal apparatus (information processing apparatus) 100 according to the second embodiment has a hardware configuration similar to that of the terminal apparatus (information processing apparatus) 100 according to the first embodiment illustrated in FIG. 2. The printer (printing apparatus) 200 according to the second embodiment has a hardware configuration similar to that of the printer (printing apparatus) 200 according to the first embodiment illustrated in FIG. 3.

The foregoing first embodiment is configured so that the user manual activation instruction signal 1100 is transmitted to the terminal apparatus (information processing apparatus) 100 communicatively connected to the printer 200 when the help button 450 of the printer (printing apparatus) 200 is operated. Moreover, in the present embodiment, the information processing apparatus 100 displays the user manual information about the user manual of the printer 200 based on the received user manual activation instruction signal 1100. The foregoing first embodiment has the following two challenges.

The first challenge is that when the help button 450 of the printer (printing apparatus) 200 is operated, the terminal apparatus (information processing apparatus) 100 cannot determine which model of printer 200 to display user manual information about. Functions supported by the printer 200 and troubleshooting methods in the event of errors vary from one printer model to another. To present optimal user manual information to the user, the user manual information about the model of printer 200 where the help button 450 is operated thus needs to be displayed.

The second challenge is that when the help button 450 of the printer (printing apparatus) 200 is operated, the terminal apparatus (information processing apparatus) 100 cannot determine in which display language to display the user manual information. The user manual information is desirably displayed in a language optimal for the user.

The second embodiment describes a mode that enables display of the user manual information about an appropriate model in the optimal language, in addition to the method of the foregoing first embodiment.

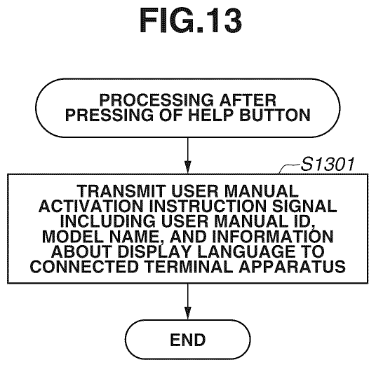

FIG. 13 is a flowchart illustrating a control method of the printing system 10 according to the second embodiment, and shows an example of processing of the printer 200 when the help button 450 on the operation panel 260 of the printer (printing apparatus) 200 is pressed.

In the second embodiment, when the user presses the help button 450 on the operation panel 260 of the printer (printing apparatus) 200, the processing proceeds to step S1301 of FIG. 13.

In step S1301 of FIG. 13, the input/output I/F 250 transmits a user manual activation instruction signal for the user manual of the printer 200 to the communicatively connected terminal apparatus (information processing apparatus) 100 based on control of the CPU 210. Specifically, in step S1301, the input/output I/F 250 transmits a user manual activation instruction signal including a user manual ID for identifying the user manual of the printer 200, a model name of the printer 200, and information about a display language of the printer 200. For example, the display language of the printer 200 here is the language in which information is displayed on the information display unit 410 of the printer 200. The input/output I/F 250 of the printer 200 that transmits the user manual activation instruction signal in step S1301 of FIG. 13 serves as the transmission unit.

In the present embodiment, in step S1301 of FIG. 13, the information display unit 410 of the operation panel 260 of the printer (printing apparatus) 200 displays information about the foregoing user manual activation instruction signal based on control of the CPU 210. The information display unit 410 of the printer 200 that displays this information about the user manual activation instruction signal serves as the first display unit.

Once the processing of step S1301 in FIG. 13 ends, the processing of the flowchart illustrated in FIG. 13 ends.

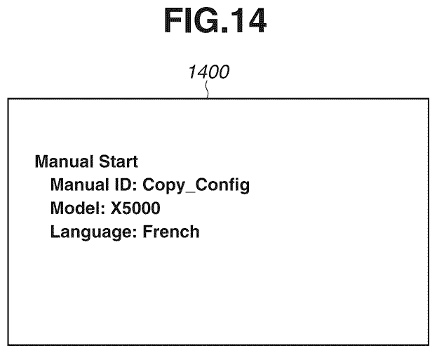

FIG. 14 is a diagram illustrating the second embodiment, and shows an example of a user manual activation instruction signal 1400 that the printer (printing apparatus) 200 transmits to the communicatively connected terminal apparatus (information processing apparatus) 100 when the help button 450 is pressed in the state illustrated in FIG. 5.

The user manual activation instruction signal 1400 illustrated in FIG. 14 includes “Model” information indicating the model name of the printer 200 and “Language” information indicating the display language of the printer 200 in addition to the information of the user manual activation instruction signal 1100 illustrated in FIG. 11. Specifically, for example, the user manual activation instruction signal 1400 illustrated in FIG. 14 includes “Model: X5000”, which indicates that the model name of the printer 200 is X5000. The user manual activation instruction signal 1400 illustrated in FIG. 14 also includes “Language: French”, which indicates that the display language of the printer 200 is French.

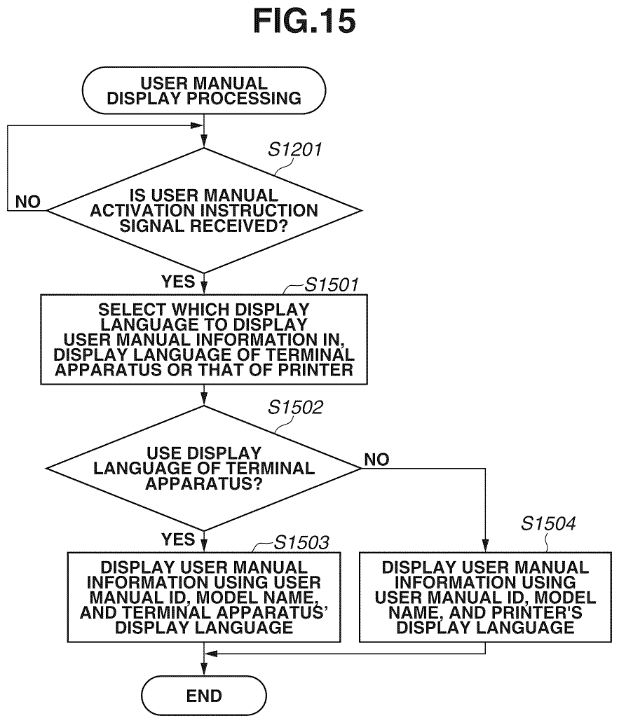

FIG. 15 is a flowchart illustrating a control method of the printing system 10 according to the second embodiment, and shows an example of processing of the terminal apparatus (information processing apparatus) 100 when the user manual activation instruction signal 1400 is transmitted from the communicatively connected printer (printing apparatus) 200. In the flowchart illustrated in FIG. 15, processing similar to that of the processing steps of the flowchart illustrated in FIG. 12 is denoted by the same step numbers. A detailed description thereof will be omitted.

When the processing of the flowchart illustrated in FIG. 15 is started, processing similar to that of step S1201 in FIG. 12 is performed.

In a case where, in step S1201 of FIG. 15, the communication unit 160 (application 102) determines that the user manual activation instruction signal 1400 is received from the communicatively connected printer (printing apparatus) 200 (YES in step S1201), the processing proceeds to step S1501. Here, the communication unit 160 of the terminal apparatus (information processing apparatus) 100 that performs the processing for receiving the user manual activation instruction signal 1400 serves as a reception unit.

In step S1501 of FIG. 15, the CPU 110 prompts the user to select in which display language to display the user manual information on the display unit 150, between the display language of the terminal apparatus 100 and that of the printer 200.

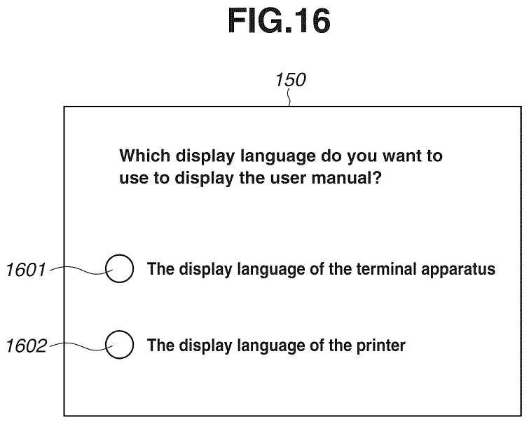

FIG. 16 is a diagram illustrating the second embodiment, and shows an example of a selection screen that is displayed on the display unit 150 of the terminal apparatus (information processing apparatus) 100 to have the user select the display language in step S1501 of FIG. 15. The selection screen on the display unit 150 illustrated in FIG. 16 includes a button 1601 to be operated when the user selects the display language of the terminal apparatus 100 as that for the user manual information, and a button 1602 to be operated when the user selects the display language of the printer 200.

In the present embodiment, the CPU 110 performs the processing for selecting which display language to display the user manual information in, the display language of the terminal apparatus 100 or that of the printer 200, based on the user's selection operation using the selection screen illustrated in FIG. 16. The CPU 110 of the terminal apparatus (information processing apparatus) 100 performing this display language selection processing serves as a selection unit.

Returning to the description of FIG. 15.

Once the processing of step S1501 in FIG. 15 ends, the processing proceeds to step S1502.

In step S1502 of FIG. 15, the CPU 110 determines whether to use the display language of the terminal apparatus 100 as that for the user manual information based on the user's selection operation using the selection screen illustrated in FIG. 16.

In a case where, in step S1502 of FIG. 15, the CPU 110 determines to use the display language of the terminal apparatus 100 as that for the user manual information (YES in step S1502), the processing proceeds to step S1503.

In step S1503 of FIG. 15, the display unit 150 displays the user manual information about the printer 200 using the user manual ID, the model name of the printer 200, and the display language of the terminal apparatus 100 based on the user manual activation instruction signal 1400 received by the communication unit 160.

In a case where, in step S1502 of FIG. 15, the CPU 110 determines to not use the display language of the terminal apparatus 100 as that for the user manual information (to use the display language of the printer 200) (NO in step S1502), the processing proceeds to step S1504.

In step S1504 of FIG. 15, the display unit 150 displays the user manual information about the printer 200 using the user manual ID, the model name of the printer 200, and the display language of the printer 200 based on the user manual activation instruction signal 1400 received by the communication unit 160.

Once the processing of step S1503 or S1504 in FIG. 15 ends, the processing of the flowchart illustrated in FIG. 15 ends. The display unit 150 of the terminal apparatus (information processing apparatus) 100 that displays the user manual information in separation S1503 or S1504 of FIG. 15 serves as the second display unit.

In the printing system 10 according to the second embodiment described above, the user manual activation instruction signal 1400 includes the user manual ID for identifying the user manual of the printer (printing apparatus) 200, the model name of the printer 200, and the information about the display language of the printer 200. The CPU 110 of the terminal apparatus (information processing apparatus) 100 then performs processing for selecting which display language to display the user manual information in, the display language of the terminal apparatus 100 or that of the printer 200. The display unit 150 of the terminal apparatus 100 then displays the user manual information in the display language selected by the CPU 110, and displays the user manual ID and the model name of the printer 200 included in the user manual activation instruction signal 1400.

According to the second embodiment, in addition to the effects of the foregoing first embodiment, the user manual information about the optimal model can be displayed on the display unit 150 of the terminal apparatus 100 in the optimal language.

### Third Embodiment

Next, a third embodiment will be described. In the following description of the third embodiment, items common to the foregoing first and second embodiments are omitted, and differences from the foregoing first and second embodiments will be described.

A printing system according to the third embodiment has a schematic configuration similar to that of the printing system 10 according to the first embodiment illustrated in FIG. 1. The terminal apparatus (information processing apparatus) 100 according to the third embodiment has a hardware configuration similar to that of the terminal apparatus (information processing apparatus) 100 according to the first embodiment illustrated in FIG. 2. The printer (printing apparatus) 200 according to the third embodiment has a hardware configuration similar to that of the printer (printing apparatus) 200 according to the first embodiment illustrated in FIG. 3.

The foregoing first embodiment is predicated on that the user manual information about the printer (printing apparatus) 200 is stored in the ROM 230 of the terminal apparatus (information processing apparatus) 100. However, there may be cases where the user manual information about the printer 200 is not stored. The third embodiment deals with a mode where user manual information about the printer 200 located on a web page is displayed in a case where the user manual information about the printer 200 is not stored in the ROM 230 of the terminal apparatus 100.

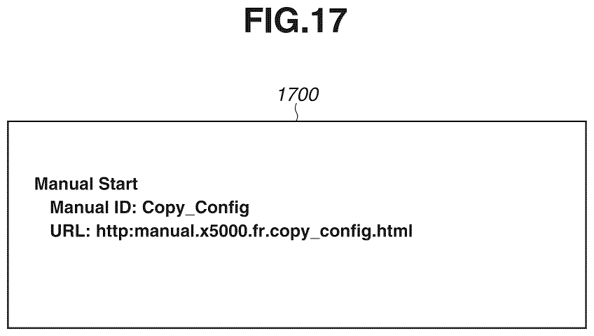

FIG. 17 is a diagram illustrating the third embodiment, and shows an example of a user manual activation instruction signal 1700 that the printer (printing apparatus) 200 transmits to the communicatively connected terminal apparatus (information processing apparatus) 100 when the help button 450 is pressed in the state illustrated in FIG. 5.

The user manual activation instruction signal 1700 illustrated in FIG. 17 includes Uniform Resource Locator (URL) information about the web page where the user manual information to be displayed is located, in addition to the information of the user manual activation instruction signal 1100 illustrated in FIG. 11.

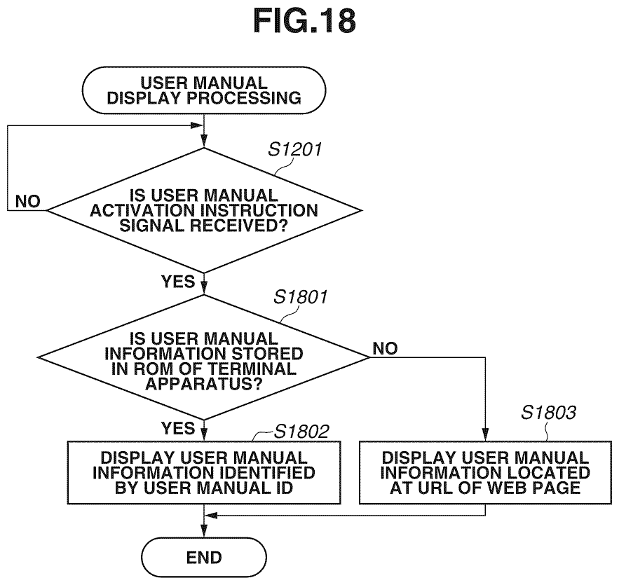

FIG. 18 is a flowchart illustrating a control method of the printing system 10 according to the third embodiment, and shows an example of processing of the terminal apparatus (information processing apparatus) 100 when the user manual activation instruction signal 1700 is transmitted from the communicatively connected printer (printing apparatus) 200. In the flowchart illustrated in FIG. 18, processing similar to that of the processing steps of the flowchart illustrated in FIG. 12 is denoted by the same step numbers. A detailed description thereof will be omitted.

When the processing of the flowchart illustrated in FIG. 18 is started, processing similar to that of step S1201 in FIG. 12 is performed.

In a case where, in step S1201 of FIG. 18, the communication unit 160 (application 102) determines that the user manual activation instruction signal 1700 is received from the communicatively connected printer (printing apparatus) 200 (YES in step S1201), the processing proceeds to step S1801. Here, the communication unit 160 of the terminal apparatus (information processing apparatus) 100 that performs the processing for receiving the user manual activation instruction signal 1700 serves as a reception unit.

In step S1801 of FIG. 18, the CPU 110 determines whether the user manual information about the user manual of the printer (printing apparatus) 200 is stored in the ROM 230 of the terminal apparatus (information processing apparatus) 100.

In a case where, in step S1801 of FIG. 18, the CPU 110 determines that the user manual information about the printer 200 is stored in the ROM 230 of the terminal apparatus 100 (YES in step S1801), the processing proceeds to step S1802.

In step S1802 of FIG. 18, the display unit 150 displays, as the user manual information, the information on the description page identified by the user manual ID included in the user manual activation instruction signal 1700 among user manuals stored in the ROM 230.

In a case where, in step S1801 of FIG. 18, the CPU 110 determines that the user manual information about the printer 200 is not stored in the ROM 230 of the terminal apparatus 100 (NO in step S1801), the processing proceeds to step S1803.

In step S1803 of FIG. 18, the display unit 150 displays the user manual information located at the URL of the web page included in the user manual activation instruction signal 1700.

Once the processing of step S1802 or S1803 in FIG. 18 ends, the processing of the flowchart illustrated in FIG. 18 ends. The display unit 150 of the information processing apparatus (information processing apparatus) 100 that displays the user manual information in step S1802 or S1803 of FIG. 18 serves as the second display unit.

In the printing system 10 according to the third embodiment described above, the user manual activation instruction signal 1700 includes the user manual ID for identifying the user manual of the printer (printing apparatus) 200 and the information about the URL of the web page where the user manual information is located. In a case where the user manual of the printer 200 is not stored in the own apparatus, the display unit 150 of the terminal apparatus 100 displays the user manual information located at the URL of the web page included in the user manual activation instruction signal 1700.

According to the third embodiment, in addition to the effects of the foregoing first embodiment, the user manual information from the web can be displayed in a case where the user manual of the printer 200 is not stored in the terminal apparatus 100.

The third embodiment may be implemented in combination with the foregoing second embodiment.

### Fourth Embodiment

Next, a fourth embodiment will be described. In the following description of the fourth embodiment, items common to the foregoing first to third embodiments are omitted, and differences from the foregoing first to third embodiments will be described.

A printing system according to the fourth embodiment has a schematic configuration similar to that of the printing system 10 according to the first embodiment illustrated in FIG. 1. The terminal apparatus (information processing apparatus) 100 according to the fourth embodiment has a hardware configuration similar to that of the terminal apparatus (information processing apparatus) 100 according to the first embodiment illustrated in FIG. 2. The printer (printing apparatus) 200 according to the fourth embodiment has a hardware configuration similar to that of the printer (printing apparatus) 200 according to the first embodiment illustrated in FIG. 3.

The foregoing first embodiment is configured so that the user manual activation instruction signal 1100 is transmitted to the terminal apparatus (information processing apparatus) 100 communicatively connected to the printer 200 when the help button 450 that is a predetermined button on the printer (printing apparatus) 200 is pressed. The fourth embodiment deals with a mode where a user manual activation instruction signal is automatically transmitted without the help button 450 on the printer 200 being pressed, for example, in the event of errors such as a paper-out error and a paper jam error during printing being performed by the printer 200.

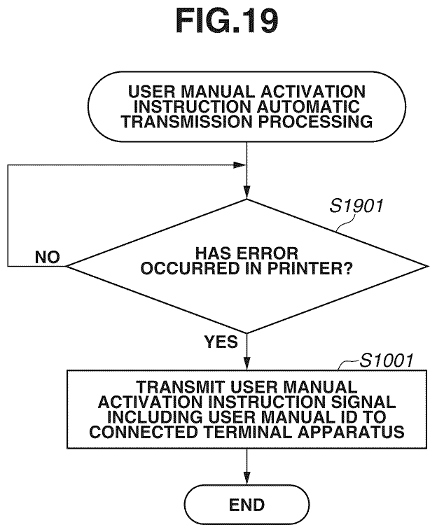

FIG. 19 is a flowchart illustrating a control method of the printing system 10 according to the fourth embodiment, and shows an example of processing of the printer 200 when an error occurs in the printer (printing apparatus) 200. In the flowchart illustrated in FIG. 19, processing similar to that of the processing steps of the flowchart illustrated in FIG. 10 is denoted by the same step numbers.

In step S1901 of FIG. 19, the CPU 210 initially determines whether an error has occurred in the printer (printing apparatus) 200. In a case where, in step S1901 of FIG. 19, the CPU 210 determines that no error has occurred in the printer 200 (NO in step S1901), the processing returns to step S1901 for standby.

In a case where, in step S1901 of FIG. 19, the CPU 210 determines that an error has occurred in the printer 200 (YES in step S1901), the processing proceeds to step S1001.

In step S1001 of FIG. 19, the input/output I/F 250 transmits a user manual activation instruction signal for the user manual of the printer 200 to the communicatively connected terminal apparatus (information processing apparatus) 100 based on control of the CPU 210. Specifically, in step S1001, the input/output I/F 250 transmits a user manual activation instruction signal including information about the user manual ID for identifying the user manual of the printer 200. The input/output I/F 250 of the printer 200 that transmits the user manual activation instruction signal in step S1001 of FIG. 19 serves as the transmission unit.

In the present embodiment, in step S1001 of FIG. 19, the information display unit 410 of the operation panel 260 of the printer (printing apparatus) 200 displays information about the foregoing user manual activation instruction signal based on control of the CPU 210. The information display unit 410 of the printer 200 that displays this information about the user manual activation instruction serves as the first display unit.

Once the processing of step S1001 in FIG. 19 ends, the processing of the flowchart illustrated in FIG. 19 ends.

In the printing system 10 according to the fourth embodiment described above, the input/output I/F 250 of the printer (printing apparatus) 200 transmits the user manual activation instruction signal to the communicatively connected terminal apparatus 100 when an error occurs in the printer 200.

According to the fourth embodiment, when an error occurs in the printer 200, the user manual activation instruction signal can be automatically transmitted to the communicatively connected terminal apparatus 100 even without the user pressing the help button 450 of the printer 200. The user manual information about the printer 200 can thus be automatically displayed on the terminal apparatus 100 without user operation.

### Fifth Embodiment

Next, a fifth embodiment will be described. In the following description of the fifth embodiment, items common to the foregoing first to fourth embodiments are omitted, and differences from the foregoing first to fourth embodiments will be described.

A printing system according to the fifth embodiment has a schematic configuration similar to that of the printing system 10 according to the first embodiment illustrated in FIG. 1. The terminal apparatus (information processing apparatus) 100 according to the fifth embodiment has a hardware configuration similar to that of the terminal apparatus (information processing apparatus) 100 according to the first embodiment illustrated in FIG. 2. The printer (printing apparatus) 200 according to the fifth embodiment has a hardware configuration similar to that of the printer (printing apparatus) 200 according to the first embodiment illustrated in FIG. 3.

The foregoing first embodiment is configured so that the user manual activation instruction signal 1100 is transmitted to the terminal apparatus (information processing apparatus) 100 communicatively connected to the printer (printing apparatus) 200.

Suppose, for example, that a plurality of terminal apparatuses 100-1 to 100-3 is communicatively connected to the printer 200. Here, the user manual activation instruction signal is transmitted to all the terminal apparatuses 100-1 to 100-3, and the user manual information about the printer 200 is displayed. In such a case, the user manual information about the printer 200 is also displayed on the terminal apparatuses 100 being used by users other than the one using the printer 200. In view of this, the fifth embodiment deals with a mode where the user manual information about the printer 200 is displayed only on the terminal apparatus 100 being used by the user who is using the printer 200. Specifically, the fifth embodiment is configured so that the user inputs their user ID to the printer 200 before using the functions of the printer 200.

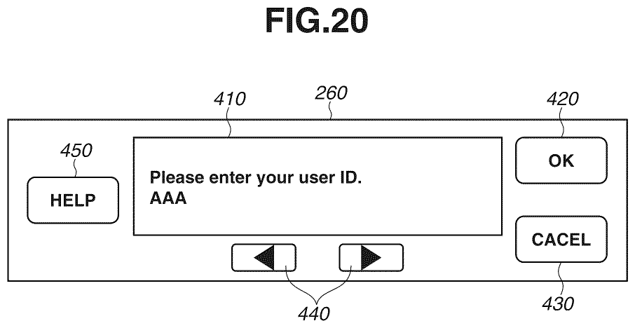

FIG. 20 is a diagram illustrating an example of the operation panel 260 of the printer (printing apparatus) 200 according to the fifth embodiment, and shows a display example where a message for having the user input their user ID is displayed on the information display unit 410. In FIG. 20, components similar to those illustrated in FIGS. 4 to 6 and 8 are denoted by the same reference numerals. A detailed description thereof will be omitted.

The information display unit 410 illustrated in FIG. 20 displays the message for prompting the user to input their user ID. Specifically, the information display unit 410 illustrated in FIG. 20 demonstrates a case where “AAA” is input as the user ID. The input (registration) of the user ID is completed when the user presses the OK button 420 on the operation panel 260 of the printer (printing apparatus) 200 illustrated in FIG. 20.

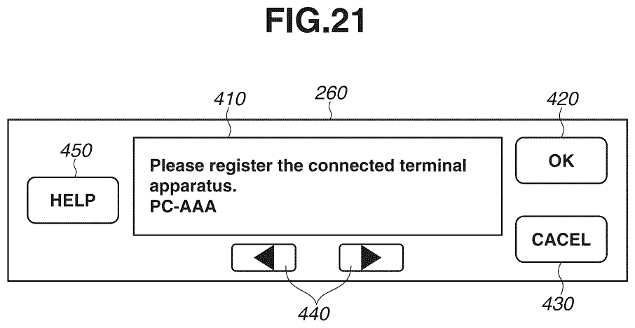

FIG. 21 is a diagram illustrating an example of the operation panel 260 of the printer (printing apparatus) 200 according to the fifth embodiment, and shows a display example where the information display unit 410 displays a message for registering the terminal apparatus (information processing apparatus) 100 being used by the user and communicatively connected to the printer 200. In FIG. 21, components similar to those illustrated in FIGS. 4 to 6, 8, and 20 are denoted by the same reference numerals. A detailed description thereof will be omitted.

The information display unit 410 illustrated in FIG. 21 demonstrates a case where “PC-AAA” is input as the terminal apparatus (information processing apparatus) 100 being used by the user and communicatively connected to the printer (printing apparatus) 200. The input (registration) of the terminal apparatus 100 being used by the user and communicatively connected to the printer 200 is completed when the user presses the OK button 420 on the operation panel 260 of the printer (printing apparatus) 200 illustrated in FIG. 21.

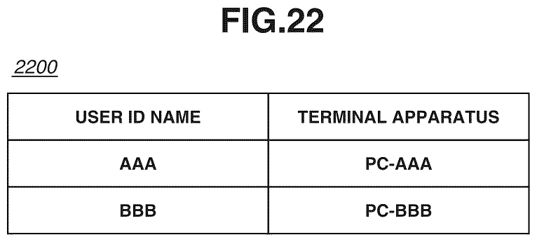

FIG. 22 is a chart illustrating an example of an association information table 2200 that is held in the ROM 230 of the printer (printing apparatus) 200 according to the fifth embodiment, where information about users is associated with information about the users'terminal apparatuses (information processing apparatuses) 100. In the present embodiment, the ROM 230 of the printer (printing apparatus) 200 holding the association information table 2200 illustrated in FIG. 22 serves as a holding unit.

Specifically, the association information table 2200 illustrated in FIG. 22 demonstrates an example where “user ID name” is applied as the user information, and “terminal apparatus” is applied as the information about the user's terminal apparatus (information processing apparatus) 100. The printer (printing apparatus) 200 updates and holds the association information table 2200 illustrated in FIG. 22 as needed. More specifically, two pairs of pieces of association information “user ID name: AAA, terminal apparatus: PC-AAA” and “user ID name: BBB, terminal apparatus: PC-BBB” are registered in the association information table 2200 illustrated in FIG. 22.

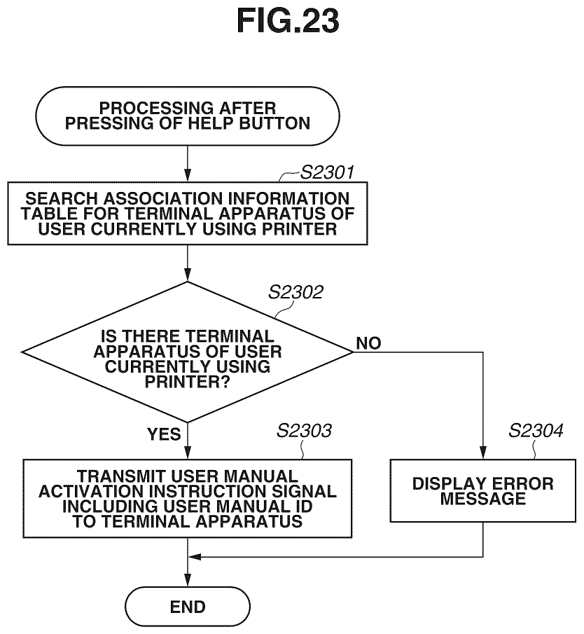

FIG. 23 is a flowchart illustrating a control method of the printing system 10 according to the fifth embodiment, and shows an example of processing of the printer 200 when the help button 450 on the operation panel 260 of the printer (printing apparatus) 200 is pressed.

In the fifth embodiment, when the help button 450 on the operation panel 260 of the printer (printing apparatus) 200 is pressed by the user, the processing proceeds to step S2301 of FIG. 23.

In step S2301 of FIG. 23, the CPU 210 performs processing for searching for a terminal apparatus (information processing apparatus) 100 that is of the user currently using the printer 200 and is communicatively connected to the printer 200. Here, the user currently using the printer 200 refers to the one whose user ID is input and registered from the information display unit 410 illustrated in FIG. 20. The CPU 210 then searches for the terminal apparatus 100 associated with the user ID input and registered from the information display unit 410 illustrated in FIG. 20, using the association information table 2200 illustrated in FIG. 22.

In step S2302 of FIG. 23, the CPU 210 determines whether there is a terminal apparatus 100 associated with the user ID of the user currently using the printer 200 based on the result of the search performed in step S2301.

In a case where, in step S2302 of FIG. 23, the CPU 210 determines that there is a terminal apparatus 100 associated with the user ID of the user currently using the printer 200 (YES in step S2302), the processing proceeds to step S2303.

In step S2303 of FIG. 23, the input/output I/F 250 transmits a user manual activation instruction signal for the user manual of the printer 200 to the terminal apparatus (information processing apparatus) 100 associated with the user ID of the user currently using the printer 200. For example, in a case where the user ID of the user currently using the printer 200 has a user ID name “AAA” in the association information table 2200 illustrated in FIG. 22, the input/output I/F 250 transmits the user manual activation instruction signal to the terminal apparatus “PC-AAA”. Specifically, in step S2303, the input/output I/F 250 transmits a user manual activation instruction signal including information about the user manual ID for identifying the user manual of the printer 200. The input/output I/F 250 of the printer 200 that transmits the user manual activation instruction signal in step S2303 of FIG. 23 serves as the transmission unit.

In the present embodiment, in step S2303 of FIG. 23, the information display unit 410 of the operation panel 260 of the printer (printing apparatus) 200 displays information about the foregoing user manual activation instruction signal based on control of the CPU 210. The information display unit 410 of the printer 200 that displays this information about the user manual activation instruction signal serves as the first display unit.

In a case where, in step S2302 of FIG. 23, the CPU 210 determines that there is no terminal apparatus 100 associated with the user ID of the user currently using the printer 200 (NO in step S2302), the processing proceeds to step S2304.

In step S2304 of FIG. 23, the information display unit 410 of the operation panel 260 of the printer (printing apparatus 200) displays an error message based on control of the CPU 210.

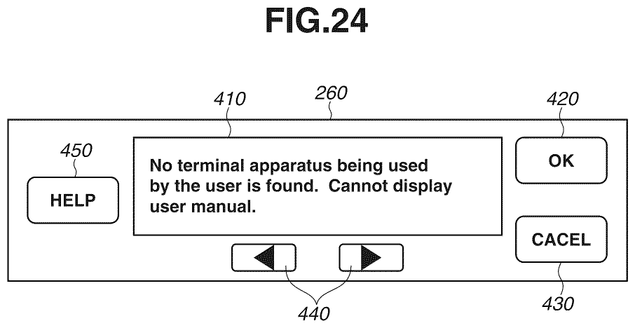

FIG. 24 is a diagram illustrating an example of the operation panel 260 of the printer (printing apparatus) 200 according to the fifth embodiment, and shows a display example where error message information is displayed on the information display unit 410 in step S2304 of FIG. 23. In FIG. 24, components similar to those illustrated in FIGS. 4 to 6, 8, 20, and 21 are denoted by the same reference numerals. A detailed description thereof will be omitted.

The information display unit 410 illustrated in FIG. 24 displays error message information including information that no terminal apparatus 100 of the user currently using the printer 200 is found.

Returning to the description of FIG. 23.

Once the processing of step S2303 or S2304 in FIG. 23 ends, the processing of the flowchart illustrated in FIG. 23 ends.

In the printing system 10 according to the fifth embodiment described above, the printer (printing apparatus) 200 includes the ROM 230 (holding unit) that holds the association information table 2200 where information about users and information about the users'information processing apparatuses are associated with each other. The input/output I/F 250 (transmission unit) of the printer 200 identifies the terminal apparatus (information processing apparatus) 100 associated with user information input to the printer 200, using the association information table 2200. The input/output I/F 250 (transmission unit) of the printer 200 transmits the user manual activation transmission signal for the user manual of the printer 200 to the identified terminal apparatus 100 (step S2303 of FIG. 23). The information display unit 410 (first display unit) of the printer 200 displays error-indicating information (step S2304 of FIG. 23) in a case where no terminal apparatus 100 of the user associated with the user information input to the printer 200 is found in the association information table 2200.

According to the fifth embodiment, the user manual information about the printer 200 can be displayed only on the terminal apparatus 100 of the user currently using the printer 200.

The fifth embodiment may be implemented in combination with the foregoing second to fourth embodiments.

### Sixth Embodiment

Next, a sixth embodiment will be described. In the following description of the sixth embodiment, items common to the foregoing first to fifth embodiments are omitted, and differences from the foregoing first to fifth embodiments will be described.

The sixth embodiment describes a mode where a printer (printing apparatus) 200 transmits a user manual activation instruction signal to a terminal apparatus (information processing apparatus) 100 via a server apparatus (specifically, in the present embodiment, a push notification server) communicatively connected to the Internet.

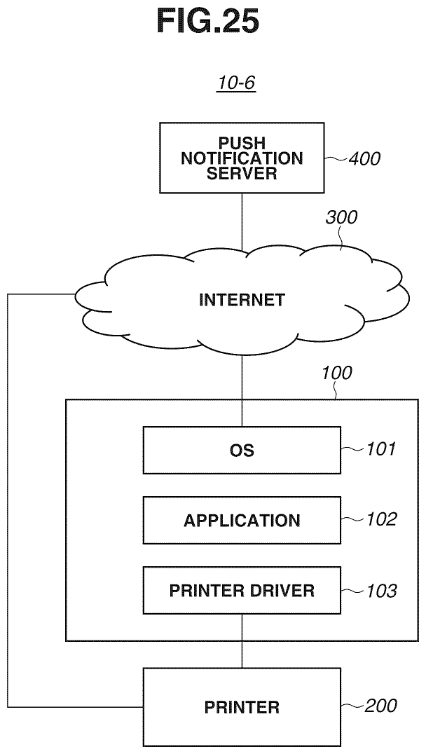

FIG. 25 is a diagram illustrating an example of a schematic configuration of a printing system 10 according to the sixth embodiment.

In the following description, as illustrated in FIG. 25, the printing system 10 according to the sixth embodiment may be referred to as a “printing system 10-6” when needed. In FIG. 25, components similar to those illustrated in FIG. 1 are denoted by the same reference numerals. A detailed description thereof will be described.

The printing system 10-6 includes the Internet 300 and a push notification server (server apparatus) 400 in addition to a terminal apparatus (information processing apparatus) 100 and a printer (printing apparatus) 200 similar to those illustrated in FIG. 1. The terminal apparatus 100 and the printer 200 can communicate with the push notification server 400 via the Internet 300. The Internet 300 connects the terminal apparatus 100, the printer 200, and the push notification server 400 to enable mutual communication therebetween.

The terminal apparatus (information processing apparatus) 100 according to the sixth embodiment has a hardware configuration similar to that of the terminal apparatus (information processing apparatus) 100 according to the first embodiment illustrated in FIG. 2. The printer (printing apparatus) 200 according to the sixth embodiment has a hardware configuration similar to that of the printer (printing apparatus) 200 according to the first embodiment illustrated in FIG. 3.

The push notification server 400 is a server apparatus having a function of distributing push notifications to the user's terminal apparatus (information processing apparatus) 100, for example. When the user permits notifications for the application 102 via the terminal apparatus 100, identification information about the terminal apparatus 100 is transmitted to and registered with the push notification server 400. The push notification server 400 then transmits push notifications to the registered terminal apparatus 100, whereby the push notifications arrive at the registered terminal apparatus 100. Upon arrival of a push notification from the push notification server 400, the OS 101 of the terminal apparatus 100 displays the push notification on the display unit 150 of the terminal apparatus 100.

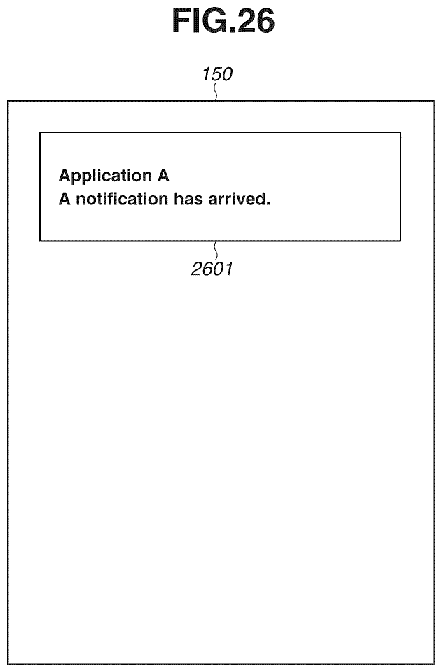

FIG. 26 is a diagram illustrating a display example of a push notification from the push notification server (server apparatus) 400 on the display unit 150 of the terminal apparatus (information processing apparatus) 100 according to the sixth embodiment. Specifically, the display unit 150 of the terminal apparatus 100 illustrated in FIG. 26 displays a push notification 2601 delivered from the push notification server 400. When the user selects the push notification 2601 displayed on the display unit 150, the OS 101 of the terminal apparatus 100 launches the application 102, and the application 102 processes the content of the push notification 2601.

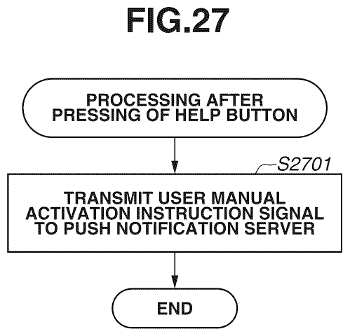

FIG. 27 is a flowchart illustrating a control method of the printing system 10 according to the sixth embodiment, and shows an example of processing of the printer 200 when the help button 450 on the operation panel 260 of the printer (printing apparatus) 200 is pressed.

In the sixth embodiment, when the user presses the help button 450 on the operation panel 260 of the printer (printing apparatus) 200, the processing proceeds to step S2701 of FIG. 27.

In step S2701 of FIG. 27, the input/output I/F 250 transmits a user manual activation instruction signal as a push notification to the push notification server (server apparatus) 400 communicatively connected via the Internet 300. The content of the user manual activation instruction signal transmitted in step S2701 is similar to that of the user manual activation instruction signal described in any one of the foregoing first to fifth embodiments. A description thereof will thus be omitted. The input/output I/F 250 of the printer 200 that transmits the user manual activation instruction signal in step S2701 of FIG. 27 serves as the transmission unit.

In the present embodiment, in step S2701 of FIG. 27, the information display unit 410 of the operation panel 260 of the printer (printing apparatus) 200 displays information about the foregoing user manual activation instruction signal based on control of the CPU 210. The information display unit 410 of the printer 200 that displays this information about the user manual activation instruction signal serves as the first display unit.

Once the processing of step S2701 in FIG. 27 ends, the processing of the flowchart of FIG. 27 ends.

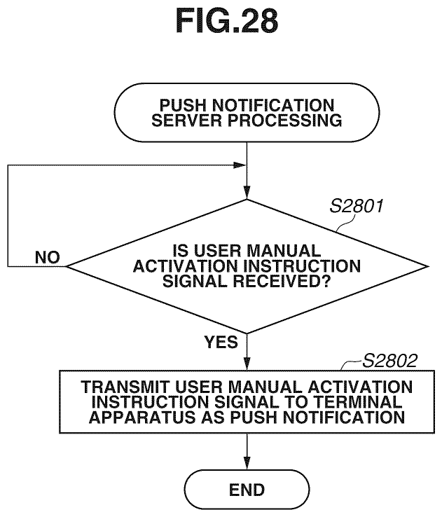

FIG. 28 is a flowchart illustrating a control method of the printing system 10 according to the sixth embodiment, and shows an example of processing of the push notification server (server apparatus) 400 when the user manual activation instruction signal is transmitted from the printer (printing apparatus) 200.

In step S2801 of FIG. 28, the push notification server (server apparatus) 400 determines whether a user manual activation instruction signal is received from the printer 200 communicatively connected via the Internet 300. In a case where, in step S2801 of FIG. 28, the push notification server 400 determines that no user manual activation instruction signal is received from the printer 200 via the Internet 300 (NO in step S2801), the processing remains in standby step S2801.

In a case where, in step S2801 of FIG. 28, the push notification server 400 determines that a user manual activation instruction signal is received from the printer 200 via the Internet 300 (YES in step S2801), the processing proceeds to step S2802.

In step S2802 of FIG. 28, the push notification server (server apparatus) 400 transmits the user manual activation instruction signal as a push notification to the terminal apparatus (information processing apparatus) 100 communicatively connected via the Internet 300.

Once the processing of step S2802 in FIG. 28 ends, the processing of the flowchart illustrated in FIG. 28 ends.

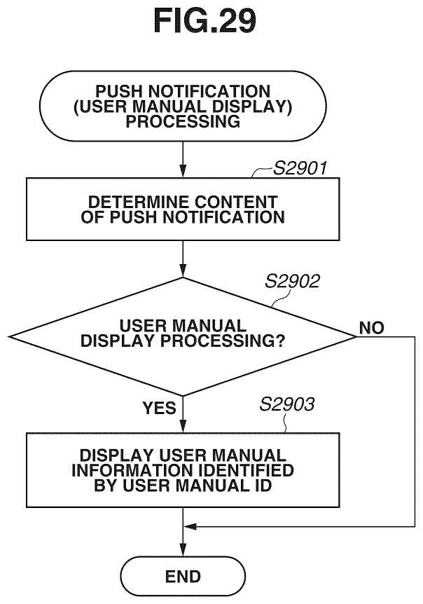

FIG. 29 is a flowchart illustrating a control method of the printing system 10 according to the sixth embodiment, and shows an example of processing of the terminal apparatus (information processing apparatus) 100 when a push notification is transmitted from the push notification server (server apparatus) 400.

In step S2901 of FIG. 29, the CPU 110 (application 102 launched by the OS 101) determines the content of the push notification transmitted from the push notification server (server apparatus) 400.

In step S2902 of FIG. 29, the CPU 110 determines whether the content of the push notification determined in step S2901 is user manual display processing based on the foregoing user manual activation instruction signal.

In a case where, in step S2902 of FIG. 29, the CPU 110 determines that the content of the push notification determined in step S2901 is the user manual display processing based on the foregoing user manual activation instruction signal (YES in step S2902), the processing proceeds to step S2903.

In step S2903 of FIG. 29, the display unit 150 displays, as user manual information, the information on the description page identified by the user manual ID included in the user manual activation instruction signal related to the push notification among user manuals stored in the ROM 230. The display unit 150 of the terminal apparatus (information processing apparatus) 100 that displays the user manual information in step S2903 of FIG. 29 serves as the second display unit.

Once the processing of step S2903 in FIG. 29 ends, the processing of the flowchart illustrated in FIG. 29 ends. In a case where, in step S2902 of FIG. 29, the CPU 110 determines that the content of the push notification is other than the user manual display processing based on the foregoing user manual activation instruction signal (NO in step S2902), the processing of the flowchart illustrated in FIG. 29 ends. In a case where the determination in the step S2902 of FIG. 29 is negative (NO in step S2902), other processing indicated by the content of the push notification may be performed without terminating the processing of the flowchart illustrated in FIG. 29.

The printing system 10 according to the sixth embodiment described above includes the Internet 300 and the push notification server (server apparatus) 400 in addition to the terminal apparatus (information processing apparatus) 100 and the printer (printing apparatus) 200 according to the first embodiment. The input/output I/F 250 (transmission unit) of the printer 200 transmits the user manual activation instruction signal for the user manual of the printer 200 to the terminal apparatus 100 via the push notification server 400 that is another apparatus (FIGS. 27 and 28). Specifically, in the sixth embodiment, the input/output I/F 250 (transmission unit) of the printer 200 transmits the user manual activation instruction signal to the push notification server 400 that is another apparatus (step S2701 of FIG. 27). The push notification server 400 then transmits the user manual activation instruction signal received from the printer 200 to the terminal apparatus 100 (step S2802 of FIG. 28). The communication unit 160 (reception unit) of the terminal apparatus 100 then receives the user manual activation notification signal from the push notification server 400. The display unit 150 (second display unit) of the terminal apparatus 100 then displays the user manual information about the user manual of the printer 200 based on the received user manual activation instruction signal.

According to the sixth embodiment, like the first embodiment, detailed user manual information can be presented to the user in an easily understandable manner even in a case where the information display unit 410 of the printer 200 is unable to fully display the detailed user manual information because of its small display area, etc.

The sixth embodiment may be implemented in combination with the foregoing second to fifth embodiments.

### Seventh Embodiment

Next, a seventh embodiment will be described. In the following description of the seventh embodiment, items common to the foregoing first to sixth embodiments are omitted, and differences from the first to sixth embodiments will be described.

A printing system according to the seventh embodiment has a schematic configuration similar to that of the printing system 10 according to the first embodiment illustrated in FIG. 1. The terminal apparatus (information processing apparatus) 100 according to the seventh embodiment has a hardware configuration similar to that of the terminal apparatus (information processing apparatus) 100 according to the first embodiment illustrated in FIG. 2. The printer (printing apparatus) 200 according to the seventh embodiment has a hardware configuration similar to that of the printer (printing apparatus) 200 according to the first embodiment illustrated in FIG. 3.

In the foregoing first embodiment, the user manual information about the printer 200 is described to be displayed on the display unit 150 of the terminal apparatus 100 when the help button 450 of the printer (printing apparatus) 200 is operated. The seventh embodiment deals with a mode where the information display unit 410 of the printer 200 also displays message information indicating that the user manual information is displayed on the terminal apparatus 100, or summarized user manual information providing a summary of the user manual information, whereby more user-friendly information is provided to the user.

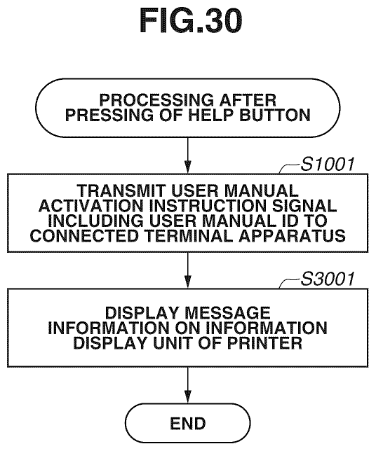

FIG. 30 is a flowchart illustrating a control method of the printing system 10 according to the seventh embodiment, and shows a first example of processing of the printer 200 when the help button 450 on the operation panel 260 of the printer (printing apparatus) 200 is pressed. In the flowchart illustrated in FIG. 30, processing similar to that of the processing steps of the flowchart illustrated in FIG. 10 is denoted by the same step numbers. A detailed description thereof will be omitted.

When the processing of the flowchart illustrated in FIG. 30 is started, processing similar to that of step S1001 in FIG. 10 is performed. More specifically, in step S1001 of FIG. 30, the input/output I/F 250 transmits a user manual activation instruction signal including information about the user manual ID to the communicatively connected terminal apparatus (information processing apparatus) 100.

In step S3001 of FIG. 30, the information display unit 410 of the printer 200 displays, as information related to the user manual activation instruction signal, message information indicating that the user manual information is displayed on the terminal apparatus 100 based on control of the CPU 210. In step S3001 of FIG. 30, the information display unit 410 that displays the message information serves as the first display unit.

Once the processing of step S3001 in FIG. 30 ends, the processing of the flowchart illustrated in FIG. 30 ends.

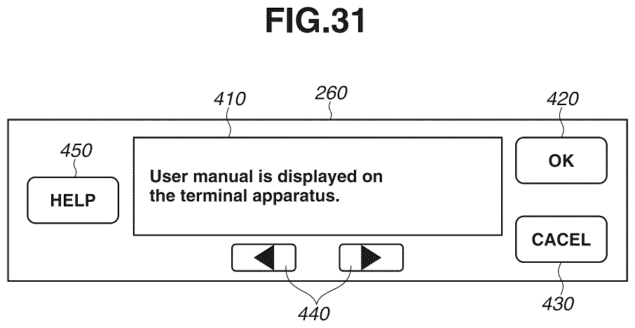

FIG. 31 is a diagram illustrating an example of the operation panel 260 of the printer (printing apparatus) 200 according to the seventh embodiment, and shows a display example where the message information is displayed on the information display unit 410 in step S3001 of FIG. 30. In FIG. 31, components similar to those illustrated in FIGS. 4 to 6, 8, 20, 21, and 24 are denoted by the same reference numerals. A detailed description thereof will be omitted.

The information display unit 410 illustrated in FIG. 31 displays message information indicating that the user manual information is displayed on the terminal apparatus 100. As illustrated in FIG. 31, displaying the foregoing message information on the information display unit 410 enables the user to recognize that the user manual information is displayed on the terminal apparatus 100.

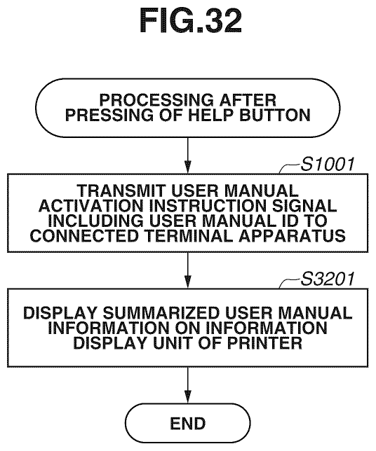

FIG. 32 is a flowchart illustrating a control method of the printing system 10 according to the seventh embodiment, and shows a second example of the processing of the printer 200 when the help button 450 on the operation panel 260 of the printer (printing apparatus) 200 is pressed. In the flowchart illustrated in FIG. 32, processing similar to that of the processing steps of the flowchart illustrated in FIG. 10 is denoted by the same step numbers. A detailed description thereof will be omitted.

When the processing of the flowchart illustrated in FIG. 32 is started, processing similar to that of step S1001 in FIG. 10 is performed. More specifically, in step S1001 of FIG. 32, the input/output I/F 250 transmits a user manual activation instruction signal including the information about the user manual ID to the communicatively connected terminal apparatus (information processing apparatus) 100.

In step S3201 of FIG. 32, the information display unit 410 of the printer 200 displays, as information related to the user manual activation instruction signal, summarized user manual information providing a summary of the foregoing user manual information based on control of the CPU 210. The information display unit 410 of the printer 200 that displays the summarized user manual information in step S3201 of FIG. 32 serves as the first display unit.

Once the processing of step S3201 in FIG. 32 ends, the processing of the flowchart illustrated in FIG. 32 ends.

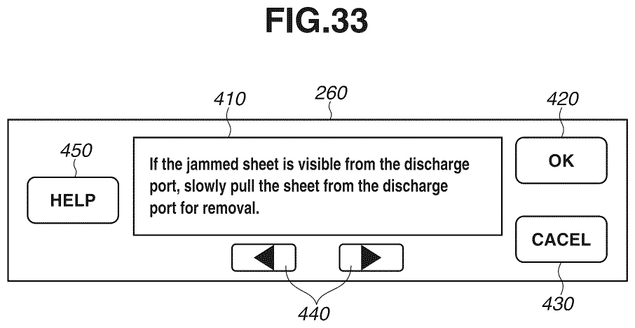

FIG. 33 is a diagram illustrating an example of the operation panel 260 of the printer (printing apparatus) 200 according to the seventh embodiment, and shows a display example where the summarized user manual information is displayed on the information display unit 410 in step S3201 of FIG. 32. In FIG. 33, components similar to those illustrated in FIGS. 4 to 6, 8, 20, 21, 24, and 31 are denoted by the same reference numerals. A detailed description thereof will be omitted.

The information display unit 410 illustrated in FIG. 33 displays the summarized user manual information providing a summary of the user manual information about the printer 200 displayed on the display unit 150 of the terminal apparatus 100.

For example, the summarized user manual information displayed on the information display unit 410 illustrated in FIG. 33 is information that is displayed when a sheet jam error occurs in the printer 200 in performing printing or copying and the user presses the help button 450.

In the seventh embodiment described above, the information display unit (first display unit) 410 of the printer 200 displays the summarized user manual information providing a summary of the user manual information displayed on the communicatively connected terminal apparatus 100 as information related to the user manual activation instruction signal. The information display unit (first display unit) 410 of the printer 200 also displays the message information indicating that the user manual information is displayed on the communicatively connected terminal apparatus 100 as information related to the user manual activation instruction signal.

According to the seventh embodiment, more user-friendly information can be provided to the user using the printer 200.

The seventh embodiment may be implemented in combination with the foregoing second to sixth embodiments.

### Eighth Embodiment

Next, an eighth embodiment will be described. In the following description of the eighth embodiment, items common to the foregoing first to seventh embodiments are omitted, and differences from the foregoing first to seventh embodiments will be described.

A printing system according to the eighth embodiment has a schematic configuration similar to that of the printing system 10 according to the first embodiment illustrated in FIG. 1. The terminal apparatus (information processing apparatus) 100 according to the eighth embodiment has a hardware configuration similar to that of the terminal apparatus (information processing apparatus) 100 according to the first embodiment illustrated in FIG. 2. The printer (printing apparatus) 200 according to the eighth embodiment has a hardware configuration similar to that of the printer (printing apparatus) 200 according to the first embodiment illustrated in FIG. 3.

The foregoing seventh embodiment is configured so that the user manual activation instruction signal is transmitted to the terminal apparatus (information processing apparatus) 100 when the help button 450 that is a predetermined button of the printer (printing apparatus) 200 is pressed. Moreover, in the seventh embodiment, when the help button 450 of the printer 200 is pressed, the summarized user manual information providing a summary of the user manual information displayed on the communicatively connected terminal apparatus 100 is displayed on the information display unit 410 of the operation panel 260. In such a case, the user may be able to resolve the issue by viewing the summarized user manual information displayed on the information display unit 410 of the operation panel 260 of the printer 200. The eighth embodiment deals with a mode of once having the user check the summarized user manual information displayed on the information display unit 410 before displaying the user manual information on the display unit 150 of the terminal apparatus 100.

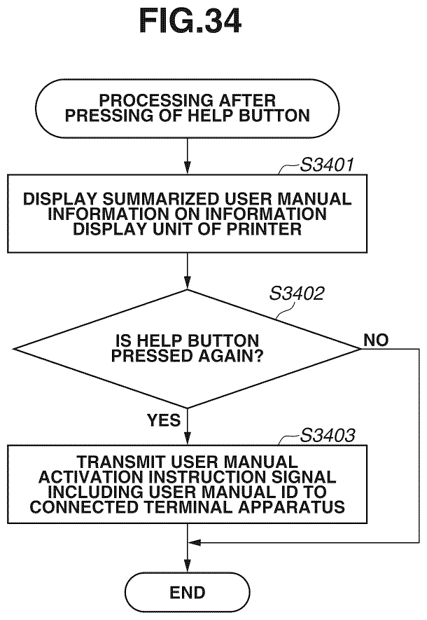

FIG. 34 is a flowchart illustrating a control method of the printing system 10 according to the eighth embodiment, and shows an example of processing of the printer 200 when the help button 450 on the operation panel 260 of the printer (printing apparatus) 200 is pressed.

In step S3401 of FIG. 34, the information display unit 410 of the operation panel 260 of the printer 200 initially displays the simple summarized user manual information providing a summary of the user manual information about the user manual of the printer 200 based on control of the CPU 210.

In step S3402 of FIG. 34, the CPU 210 determines whether the help button 450 on the operation panel 260 is pressed again by the user.

In a case where, in step S3402 of FIG. 34, the CPU 210 determines that the help button 450 on the operation panel 260 is pressed again by the user (YES in step S3402), the processing proceeds to step S3403.

In step S3403 of FIG. 34, the input/output I/F 250 of the printer 200 transmits a user manual activation instruction signal including the information about the user manual ID to the communicatively connected terminal apparatus (information processing apparatus) 100. The display unit 150 of the terminal apparatus 100 then displays the information on the description page identified by the user manual ID included in the user manual activation instruction signal among user manuals stored in the ROM 230.

Once the processing of step S3403 in FIG. 34 ends, the processing of the flowchart illustrated in FIG. 34 ends. In a case where, in step S3402 of FIG. 34, the CPU 210 determines that the help button 450 of the operation panel 260 is not pressed again by the user (NO in step S3402), the processing of the flowchart illustrated in FIG. 34 ends. In a case where the determination in step S3402 of FIG. 34 is negative (NO in step S3402), It can be considered that the user has resolved the issue by viewing the simple summarized user manual information displayed on the information display unit 410 of the printer 200, and unnecessary processing at the terminal apparatus 100 can be avoided.

In the eighth embodiment described above, in a case where the help button 450 (predetermined button) of the printer 200 is operated before the input/output I/F 250 (transmission unit) transmits the user manual activation instruction signal, the printer 200 performs the following processing. Specifically, the information display unit 410 of the operation panel 260 of the printer 200 displays the simple summarized user manual information providing a summary of the user manual information as the information related to the user manual activation instruction signal. In a case where the help button 450 of the printer 200 is then operated again, the input/output I/F 250 (transmission unit) of the printer 200 transmits the user manual activation instruction signal to the communicatively connected terminal apparatus (information processing apparatus) 100.

According to the eighth embodiment, the summarized user manual information displayed on the information display unit 410 of the printer 200 can once be checked by the user. This can sometimes prevent unnecessary processing at the terminal apparatus 100.

The eighth embodiment may be implemented in combination with the foregoing second to sixth embodiments.

### Ninth Embodiment

Next, a ninth embodiment will be described. In the following description of the ninth embodiment, items common to the foregoing first to eighth embodiments are omitted, and differences from the foregoing first to eighth embodiments will be described.

A printing system according to the ninth embodiment has a schematic configuration similar to that of the printing system 10 according to the first embodiment illustrated in FIG. 1. The terminal apparatus (information processing apparatus) 100 according to the ninth embodiment has a hardware configuration similar to that of the terminal apparatus (information processing apparatus) 100 according to the first embodiment illustrated in FIG. 2. The printer (printing apparatus) 200 according to the ninth embodiment has a hardware configuration similar to that of the printer (printing apparatus) 200 according to the first embodiment illustrated in FIG. 3.

The ninth embodiment describes a mode where guidance for communicatively connecting the printer 200 and the terminal apparatus 100 is provided in a case where there is no terminal apparatus 100 communicatively connected to the printer 200 when the help button 450 of the printer (printing apparatus) 200 is pressed.

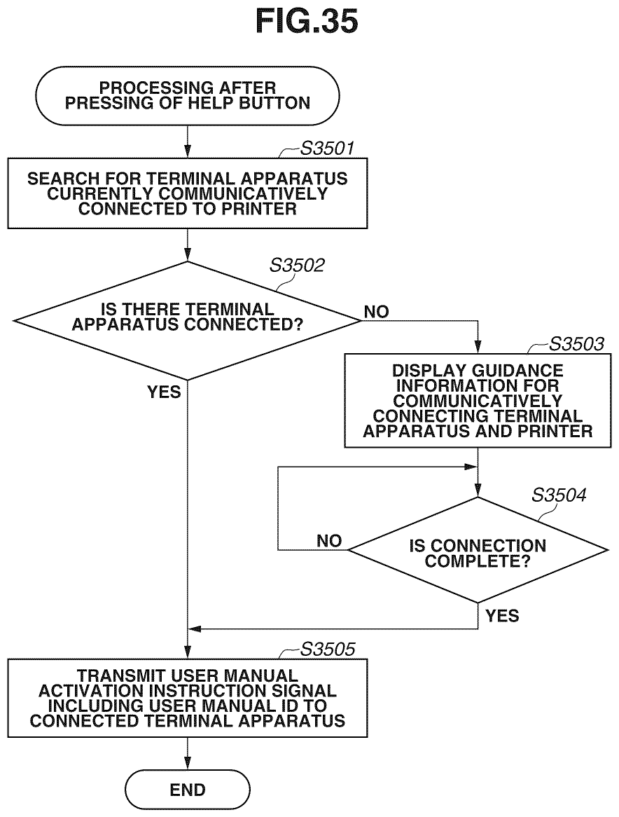

FIG. 35 is a flowchart illustrating a control method of the printing system 10 according to the ninth embodiment, and shows an example of processing of the printer 200 when the help button 450 on the operation panel 260 of the printer (printing apparatus) 200 is pressed.

In step S3501 of FIG. 35, the CPU 210 of the printer 200 searches for a terminal apparatus 100 currently communicatively connected to the printer 200.

In step S3502 of FIG. 35, the CPU 210 determines whether there is a terminal apparatus 100 currently communicatively connected to the printer 200 based on the result of the search performed in step S3502.

In a case where, in step S3502 of FIG. 35, the CPU 210 determines that there is no terminal apparatus 100 currently communicatively connected to the printer 200 (NO in step S3502), the processing proceeds to step S3503.

In step S3503 of FIG. 35, the information display unit 410 of the printer 200 displays guidance information for communicatively connecting the printer 200 and the terminal apparatus 100 based on control of the CPU 210.

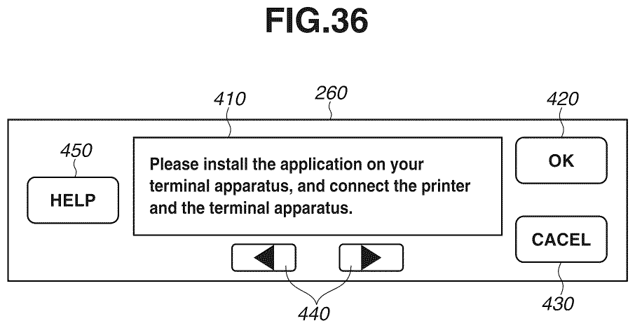

FIG. 36 is a diagram illustrating an example of the operation panel 260 of the printer (printing apparatus) 200 according to the ninth embodiment, and shows a display example where the guidance information for communicatively connecting the printer 200 and the information processing apparatus 100 is displayed on the information display unit 410 in step S3503 of FIG. 35. In FIG. 36, components similar to those illustrated in FIGS. 4 to 6, 8, 20, 21, 24, 31, and 33 are denoted by the same reference numerals. A detailed description thereof will be omitted.

The information display unit 410 illustrated in FIG. 36 displays the guidance information for communicatively connecting the printer 200 and the terminal apparatus 100.

Returning to the description of FIG. 35.

Once the processing of step S3503 in FIG. 35 ends, the processing proceeds to step S3504.

In step S3504 of FIG. 35, the CPU 210 determines whether the communication connection between the printer 200 and the terminal apparatus 100 is completed. In a case where, in step S3504 of FIG. 35, the CPU 210 determines that the communication connection between the printer 200 and the terminal apparatus 100 is not completed yet (NO in step S3504), the processing remains in standby in step S3504.

In a case where, in step S3504 of FIG. 35, the CPU 210 determines that the communication connection between the printer 200 and the terminal apparatus 100 is completed (YES in step S3504), the processing proceeds to step S3505. In a case where, in step S3502 of FIG. 35, the CPU 210 determines that there is a terminal apparatus 100 currently communicatively connected to the printer 200 (YES in step S3502), the processing also proceeds to step S3505.

In step S3505 of FIG. 35, the input/output I/F 250 of the printer 200 transmits a user manual activation instruction signal including the information about the user manual ID to the communicatively connected terminal apparatus (information processing apparatus) 100. The display unit 150 of the terminal apparatus 100 then displays, as user manual information, the information on the description page specified by the user manual ID included in the user manual activation instruction information among user manuals stored in the ROM 230.

Once the processing of step S3505 in FIG. 35 ends, the processing of the flowchart illustrated in FIG. 35 ends.

In the ninth embodiment described above, the information display unit 410 (first display unit) of the printer 200 displays the guidance information for communicatively connecting the printer 200 and the terminal apparatus 100 (step S3503 of FIG. 35) in a case where there is no communicatively connected terminal apparatus 100. When the communication connection between the printer 200 and the terminal apparatus 100 is completed, the input/output I/F 250 (transmission unit) of the printer 200 then transmits the user manual activation instruction signal to the terminal apparatus 100 (step S3505 of FIG. 35).

According to the ninth embodiment, detailed user manual information can be reliably presented to the user in an easily understandable manner even in a case where the information display unit 410 of the printer 200 is unable to fully display the detailed user manual information because of its small display area, etc.

The ninth embodiment may be implemented in combination with the foregoing first to fifth, seventh, and eighth embodiments.

### Other Embodiments

The present disclosure can also be implemented by supplying a program that realizes one or more functions of the above-described embodiments to a system or apparatus via a network or a storage medium, and by having one or more processors in a computer of the system or apparatus read and execute the program. Furthermore, it can also be implemented by a circuit (for example, an application specific integrated circuit (ASIC) that realizes one or more functions.

This program and a computer-readable storage medium storing the program are included in the present disclosure.

It should be noted that the embodiments of the present disclosure described above are merely examples of concretization for implementing the present disclosure, and should not be interpreted as limiting the technical scope of the present disclosure. That is, the present disclosure can be implemented in various forms without departing from its technical concept or principal features.

The disclosure of the embodiments includes the following configurations, a method and a program.

### Configuration 1

A printing system includes:
a printing apparatus configured to perform printing; and
an information processing apparatus configured to be communicably connected to the printing apparatus,
the printing apparatus including
a transmission unit configured to transmit a user manual activation instruction signal for a user manual of the printing apparatus to the information processing apparatus directly or via another apparatus, and
a first display unit configured to display information about the user manual activation instruction signal,
the information processing apparatus including
a reception unit configured to receive the user manual activation instruction signal, and
a second display unit configured to, in a case where the user manual activation instruction signal is received by the reception unit, display user manual information about the user manual of the printing apparatus based on the user manual activation instruction signal.

### Configuration 2

The printing system as set forth in Configuration 1, further comprising a server apparatus configured to be communicably connected to the printing apparatus and the information processing apparatus,
wherein the transmission unit of the printing apparatus is configured to transmit the user manual activation instruction signal to the server apparatus that is the another apparatus,
wherein the server apparatus is configured to transmit the user manual activation instruction signal received from the printing apparatus to the information processing apparatus, and
wherein the reception unit of the information processing apparatus is configured to receive the user manual activation instruction signal from the server apparatus.

### Configuration 3

The printing system as set forth in Configuration 1 or 2,
wherein the user manual activation instruction signal includes a user manual identifier (ID) for identifying the user manual of the printing apparatus, and
wherein the second display unit of the information processing apparatus is configured to display the user manual information about the user manual identified by the user manual ID included in the user manual activation instruction signal.

### Configuration 4

The printing system as set forth in Configuration 1 or 2,
wherein the user manual activation instruction signal includes a user manual identifier (ID) for identifying the user manual of the printing apparatus, a model name of the printing apparatus, and a display language of the printing apparatus,
wherein the information processing apparatus further includes a selection unit configured to select a display language to display the user manual information from between a display language of the information processing apparatus and the display language of the printing apparatus, and
wherein the second display unit of the information processing apparatus is configured to display the user manual information in the display language selected by the selection unit, and display the user manual ID and the model name of the printing apparatus.

### Configuration 5

The printing system as set forth in Configuration 1 or 2,
wherein the user manual activation instruction signal includes a user manual identifier (ID) for identifying the user manual of the printing apparatus and a Uniform Resource Locator (URL) of a web page where the user manual information is located, and
wherein the second display unit of the information processing apparatus is configured to, in a case where the user manual of the printing apparatus is not stored in the information processing apparatus, display the user manual information located at the URL of the web page included in the user manual activation instruction signal.

### Configuration 6

The printing system as set forth in an one of Configurations 1 to 5, wherein the transmission unit of the printing apparatus is configured to, in a case where a predetermined button disposed on the printing apparatus is operated, transmit the user manual activation instruction signal.

### Configuration 7

The printing system as set forth in any one of Configurations 1 to 5, wherein the transmission unit of the printing apparatus is configured to, in a case where an error occurs in the printing apparatus, transmit the user manual activation instruction signal.

### Configuration 8

The printing system as set forth in any one of Configurations 1 to 7,
wherein the printing apparatus further includes a holding unit configured to hold association information where information about a user and information about an information processing apparatus of the user are associated with each other, and
wherein the transmission unit of the printing apparatus is configured to identify the information processing apparatus of the user, which is associated with the information about the user input to the printing apparatus, by using the association information, and transmit the user manual activation instruction signal to the identified information processing apparatus.

### Configuration 9

The printing system as set forth in Configuration 8, wherein the first display unit of the printing apparatus is configured to, in a case where the information processing apparatus of the user, which is associated with the information about the user input to the printing apparatus, is not found in the association information, display information indicating an error.

### Configuration 10

The printing system as set forth in any one of Configurations 1 to 9, wherein the first display unit of the printing apparatus is configured to display summarized user manual information providing a summary of the user manual information as the information about the user manual activation instruction signal.

### Configuration 11

The printing system as set forth in any one of Configurations 1 to 9, wherein the first display unit of the printing apparatus is configured to display message information as the information about the user manual activation instruction signal, the message information indicating that the user manual information is displayed on the information processing apparatus.

### Configuration 12

The printing system as set forth in any one of Configurations 1 to 11,
wherein the first display unit of the printing apparatus is configured to, in a case where a predetermined button disposed on the printing apparatus is operated before the transmission unit transmits the user manual activation instruction signal, display summarized user manual information providing a summary of the user manual information as the information about the user manual activation instruction signal, and
wherein the transmission unit of the printing apparatus is configured to, in a case where the predetermined button disposed on the printing apparatus is operated again, transmit the user manual activation instruction signal.

### Configuration 13

The printing system as set forth in any one of Configurations 1 to 12,
wherein the first display unit of the printing apparatus is configured to, in a case where there is no information processing apparatus communicably connected to the printing apparatus, display information for guiding a communication connection between the printing apparatus and the information processing apparatus, and
wherein the transmission unit of the printing apparatus is configured to, in a case where the communication connection between the printing apparatus and the information processing apparatus is completed, transmit the user manual activation instruction signal to the information processing apparatus.

### Method 1

A control method of a printing system including a printing apparatus configured to perform printing and an information processing apparatus configured to be communicably connected to the printing apparatus, the control method comprising:
transmitting, by the printing apparatus, a user manual activation instruction signal for a user manual of the printing apparatus to the information processing apparatus directly or via another apparatus;
displaying, by the printing apparatus, information about the user manual activation instruction signal;
receiving, by the information processing apparatus, the user manual activation instruction signal; and
in a case where the user manual activation instruction signal is received, displaying, by the information processing apparatus, user manual information about the user manual of the printing apparatus based on the user manual activation instruction signal.

### Program 1

A program causing a computer to execute each unit of the printing system as set forth in any one of Configurations 1 to 13.

According to an embodiment of the present disclosure, detailed user manual information can be presented to users in an easily understandable manner even in a case where the information display unit of the printing apparatus is unable to fully display the detailed user manual information because of its small display area or the like.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-215472, filed Dec. 10, 2024, which is hereby incorporated by reference herein in its entirety.

What is claimed is:

1. A printing system comprising:
a printing apparatus configured to perform printing; and
an information processing apparatus configured to be communicably connected to the printing apparatus,
the printing apparatus including:
at least one memory that stores a set of instructions; and
at least one processor that executes the instructions causing the printing apparatus to perform operations comprising:
transmitting a user manual activation instruction signal for a user manual of the printing apparatus to the information processing apparatus directly or via another apparatus, and
displaying information about the user manual activation instruction signal,
the information processing apparatus including:
at least one memory that stores a set of instructions; and
at least one processor that executes the instructions causing the information processing apparatus to perform operations comprising:
receiving the user manual activation instruction signal, and
in a case where the user manual activation instruction signal is received, displaying user manual information about the user manual of the printing apparatus based on the user manual activation instruction signal.

2. The printing system according to claim 1, further comprising a server apparatus configured to be communicably connected to the printing apparatus and the information processing apparatus,
wherein the printing apparatus is configured to transmit the user manual activation instruction signal to the server apparatus that is the another apparatus,
wherein the server apparatus is configured to transmit the user manual activation instruction signal received from the printing apparatus to the information processing apparatus, and
wherein the information processing apparatus is configured to receive the user manual activation instruction signal from the server apparatus.

3. The printing system according to claim 1,
wherein the user manual activation instruction signal includes a user manual identifier (ID) for identifying the user manual of the printing apparatus, and
wherein the information processing apparatus is configured to display the user manual information about the user manual identified by the user manual ID included in the user manual activation instruction signal.

4. The printing system according to claim 1,
wherein the user manual activation instruction signal includes a user manual identifier (ID) for identifying the user manual of the printing apparatus, a model name of the printing apparatus, and a display language of the printing apparatus,
wherein the instructions further cause the information processing apparatus to perform selecting a display language to display the user manual information from between a display language of the information processing apparatus and the display language of the printing apparatus, and
wherein the information processing apparatus is configured to display the user manual information in the selected display language, and display the user manual ID and the model name of the printing apparatus.

5. The printing system according to claim 1,
wherein the user manual activation instruction signal includes a user manual identifier (ID) for identifying the user manual of the printing apparatus and a Uniform Resource Locator (URL) of a web page where the user manual information is located, and
wherein the information processing apparatus is configured to, in a case where the user manual of the printing apparatus is not stored in the information processing apparatus, display the user manual information located at the URL of the web page included in the user manual activation instruction signal.

6. The printing system according to claim 1, wherein the printing apparatus is configured to, in a case where a predetermined button disposed on the printing apparatus is operated, transmit the user manual activation instruction signal.

7. The printing system according to claim 1, wherein the printing apparatus is configured to, in a case where an error occurs in the printing apparatus, transmit the user manual activation instruction signal.

8. The printing system according to claim 1,
wherein the instructions further cause the printing apparatus to perform holding association information where information about a user and information about an information processing apparatus of the user are associated with each other, and
wherein the printing apparatus is configured to identify the information processing apparatus of the user, which is associated with the information about the user input to the printing apparatus, by using the association information, and transmit the user manual activation instruction signal to the identified information processing apparatus.

9. The printing system according to claim 8, wherein the printing apparatus is configured to, in a case where the information processing apparatus of the user, which is associated with the information about the user input to the printing apparatus, is not found in the association information, display information indicating an error.

10. The printing system according to claim 1, wherein the printing apparatus is configured to display summarized user manual information providing a summary of the user manual information as the information about the user manual activation instruction signal.

11. The printing system according to claim 1, wherein the printing apparatus is configured to display message information as the information about the user manual activation instruction signal, the message information indicating that the user manual information is displayed on the information processing apparatus.

12. The printing system according to claim 1,
wherein the printing apparatus is configured to, in a case where a predetermined button disposed on the printing apparatus is operated before the user manual activation instruction signal is transmitted, display summarized user manual information providing a summary of the user manual information as the information about the user manual activation instruction signal, and
wherein the printing apparatus is configured to, in a case where the predetermined button disposed on the printing apparatus is operated again, transmit the user manual activation instruction signal.

13. The printing system according to claim 1,
wherein the printing apparatus is configured to, in a case where there is no information processing apparatus communicably connected to the printing apparatus, display information for guiding a communication connection between the printing apparatus and the information processing apparatus, and
wherein the printing apparatus is configured to, in a case where the communication connection between the printing apparatus and the information processing apparatus is completed, transmit the user manual activation instruction signal to the information processing apparatus.

14. A control method of a printing system including a printing apparatus configured to perform printing and an information processing apparatus configured to be communicably connected to the printing apparatus, the control method comprising:
transmitting, by the printing apparatus, a user manual activation instruction signal for a user manual of the printing apparatus to the information processing apparatus directly or via another apparatus;
displaying, by the printing apparatus, information about the user manual activation instruction signal;
receiving, by the information processing apparatus, the user manual activation instruction signal; and
in a case where the user manual activation instruction signal is received, displaying, by the information processing apparatus, user manual information about the user manual of the printing apparatus based on the user manual activation instruction signal.

15. A non-transitory computer readable storage medium for storing a program causing a computer to execute each unit of the printing system according to claim 1.
